(19) United States
(12) Patent Application Publication
(10) Pub. No.: US 2015/0152299 A1
(43) Pub. Date: Jun. 4, 2015

(54) ACTIVE ENERGY RAY CURABLE ADHESIVE COMPOSITION, POLARIZING FILM AND METHOD FOR PRODUCING SAME, OPTICAL FILM AND IMAGE DISPLAY DEVICE

(71) Applicant: NITTO DENKO CORPORATION, Ibaraki-shi, Osaka (JP)

(72) Inventors: Takeshi Saito, Ibaraki-shi (JP); Miki Okamoto, Ibaraki-shi (JP); Masashi Shinagawa, Ibaraki-shi (JP); Taiyan Jiang, Ibaraki-shi (JP); Yasuaki Okada, Ibaraki-shi (JP)

(73) Assignee: NITTO DENKO CORPORATION, Ibaraki-shi, Osaka (JP)

(21) Appl. No.: 14/405,674

(22) PCT Filed: Jun. 5, 2013
(86) PCT No.: PCT/JP2013/065612

§ 371 Date: Dec. 4, 2014

(30) Foreign Application Priority Data
Jun. 8, 2012 (JP) 2012-130879
Nov. 30, 2012 (JP) 2012-263641
Jun. 3, 2013 (JP) 2013-117039

(51) Int. Cl. C09J 139/04; C09J 133/26; C09J 7/02; G02B 1/18; B32B 37/18; B32B 38/00; G02B 5/30; G02B 1/14; C09J 133/08; B32B 37/12

(52) U.S. Cl. CPC C09J 139/04; C09J 133/08; C09J 133/26; C09J 7/0203; B32B 37/1284; B32B 37/18; B32B 38/0008; G02B 5/3033; G02B 1/14; G02B 1/18; C09J 2433/00; B32B 2551/00

(57) ABSTRACT

An active energy ray-curable adhesive composition contains radically polymerizable compounds (A), (B) and (C) as curable components, and an acrylic oligomer (D) formed by polymerization of a (meth)acrylic monomer. The radically polymerizable compound (A) has an SP value of 29.0 (kJ/m3)½ to 32.0 (kJ/m3)½. The radically polymerizable compound (B) has an SP value of 18.0 (kJ/m3)½ to less than 21.0 (kJ/m3)½. The radically polymerizable compound (C) has an SP value of 21.0 (kJ/m3)½ to 23.0 (kJ/m3)½. And the composition contains 25 to 80% by weight of the radically polymerizable compound (B) based on 100% by weight of the total amount of the composition.

### TECHNICAL FIELD

The present invention relates to an active energy ray-curable adhesive composition for use in forming an adhesive layer for bonding two or more members, specifically, an active energy ray-curable adhesive composition for use in forming an adhesive layer for bonding a polarizer and a transparent protective film. The present invention also relates to a polarizing film and a method for manufacture thereof. The polarizing film can be used alone or as a part of a laminated optical film to form image display devices such as liquid crystal displays (LCDs), organic electroluminescent (EL) displays, cathode ray tubes (CRTs), and plasma display panels (PDPs).

### BACKGROUND ART

The liquid crystal display market has experienced rapid growth in many applications such as clocks, cellular phones, personal digital assistants (PDAs), notebook PCs, PC monitors, DVD players, and TVs. Liquid crystal display devices use liquid crystal switching to visualize the polarization state, and based on the display principle, they use polarizers. Particularly in TV applications and so on, higher brightness, higher contrast, and wider viewing angle are required, and polarizing films are also required to have higher transmittance, higher degree of polarization, and higher color reproducibility.

For example, iodine polarizers made of stretched polyvinyl alcohol (hereinafter, also simply referred to as “PVA”) to which iodine is adsorbed have high transmittance and high degree of polarization. Therefore, they are the most common polarizers used widely. A polarizing film commonly used includes a polarizer and transparent protective films bonded to both sides of the polarizer with a solution of a polyvinyl alcohol-based material in water, what is called an aqueous adhesive (Patent Documents 1 and 2 listed below). Transparent protective films are made of triacetylcellulose or the like, which has high water-vapor permeability.

A polarizing film can be produced using an aqueous adhesive such as a polyvinyl alcohol-based adhesive. In this case (what is called wet lamination), a drying step is necessary after a polarizer and a transparent protective film are bonded together. To increase polarizing film productivity, it is preferable to shorten the time required for such a drying step or to use an alternative bonding method with no need for any drying step.

Also when an aqueous adhesive is used, a polarizer needs to have a relatively high water content so that the adhesive can have high adhesion to the polarizer (a common polarizer has a water content of about 30%). Otherwise, the adhesive cannot provide good adhesion in the resulting polarizing film. Unfortunately, the polarizing film obtained in this way also has a problem such as a significant dimensional change at high temperature or high temperature and high humidity or low optical properties. To reduce such a dimensional change, a low-water content polarizer or a low-water-vapor-permeability transparent protective film may be used. However, if such a polarizer and such a transparent protective film are bonded together with an aqueous adhesive, drying efficiency or polarizing properties can degrade, or an appearance defect can occur, which can make it impossible to obtain practically useful polarizing films.

In recent years, as the screen size of image display devices (particularly typified by TVs) has increased, an increase in the size of polarizing films has also become very important in terms of productivity and cost (an increase in the yield or the number of available pieces). Unfortunately, polarizing films produced with the aqueous adhesive have the following problem. They can be dimensionally changed by heat from a backlight. The dimensional change can cause unevenness, so that a phenomenon in which a white part is visible against black background displayed on the whole of a screen, what is called light leakage (unevenness), can be significant.

To solve the problem with wet lamination, active energy ray-curable adhesives are proposed which contain no water or organic solvent. For example, Patent Document 3 listed below discloses an active energy ray-curable adhesive containing (A) a polar group-containing, radically polymerizable compound with a molecular weight of 1,000 or less, (B) a polar group-free, radically polymerizable compound with a molecular weight of 1,000 or less, and (D) a photopolymerization initiator. Unfortunately, this adhesive tends to have low adhesion to polarizing films because the combination of radically polymerizable compounds (monomers) as components of this adhesive is designed to improve adhesion especially to norbornene resin films.

Patent Document 4 listed below discloses an active energy ray-curable adhesive including, as essential components, a photopolymerization initiator with a molar absorption coefficient of 400 or more at a wavelength of 360 to 450 nm and an ultraviolet-curable compound. Unfortunately, when used on polarizing films, this adhesive tends to have low adhesion to polarizing films because the combination of monomers as components of this adhesive is designed to prevent warpage or deformation mainly during bonding of optical discs or the like.

Patent Document 5 listed below discloses an active energy ray-curable adhesive containing (A) a (meth)acrylic compound having two or more (meth)acryloyl groups in the molecule, (B) a (meth)acrylic compound having a hydroxyl group and only one polymerizable double bond in the molecule, and (C) a phenol ethylene oxide-modified acrylate or a nonylphenol ethylene oxide-modified acrylate based on 100 parts by weight of the total amount of the (meth)acrylic compounds. Unfortunately, in the combination of monomers as components of this adhesive, the monomers have relatively low compatibility with one another, which can cause phase separation and a risk of a reduction in the transparency of the adhesive layer. This adhesive also has a risk of reducing durability such as crack resistance because it is designed to improve adhesion by softening (reducing the Tg) of the cured product (adhesive layer). Crack resistance can be evaluated by thermal shock test (heat shock test).

The present inventors have developed a radically polymerizable, active energy ray-curable adhesive by using an N-substituted amide monomer as a curable component (Patent Documents 6 and 7 listed below). This adhesive exhibits high durability in a severe environment at high humidity and high temperature. Now, however, the market is demanding adhesives capable of providing better adhesion and/or higher water resistance.

### PRIOR ART DOCUMENTS

### Patent Documents

Patent Document 1: JP-A-2006-220732

Patent Document 2: JP-A-2001-296427

Patent Document 3: JP-A-2008-009329

Patent Document 4: JP-A-09-31416

Patent Document 5: JP-A-2008-174667

Patent Document 6: JP-A-2008-287207

Patent Document 7: JP-A-2010-78700

### SUMMARY OF THE INVENTION

### Problems to be Solved by the Invention

In recent years, the market has demanded further improvement in productivity. Thus, in particular, when a polarizer and a transparent protective film are bonded together (laminated), an attempt is made to reduce the water content of the polarizer so that the intensity of drying a polarizing film, obtained after the lamination, can be reduced. Unfortunately, some conventional active energy ray-curable adhesive compositions have insufficient adhesion to low-water content polarizers, and, in fact, further improvement in adhesion has been demanded.

It is an object of the present invention, which has been accomplished in view of these circumstances, to provide an active energy ray-curable adhesive composition capable of forming an adhesive layer that provides higher adhesion between two or more members, specifically, between a polarizer and a transparent protective film, and has a higher level of durability and water resistance.

It is another object of the present invention to provide a polarizing film having an adhesive layer that has not only good adhesion between a polarizer and a transparent protective film, even when the polarizer used has a low water content, but also a high level of durability and water resistance. It is a further object of the present invention to provide a method for manufacturing such a polarizing film and to provide an optical film and an image display device.

### Means for Solving the Problems

To solve the problems, the present inventors have focused attention on the SP (solubility parameter) values of curable components in an active energy ray-curable adhesive composition. In general, materials with SP values close to each other are considered to have high affinity for each other. For example, therefore, radically polymerizable compounds with SP values close to each other can have high compatibility with each other, and when a radically polymerizable compound in an active energy ray-curable adhesive composition has an SP value close to that of a polarizer, the resulting adhesive layer can have high adhesion to the polarizer. Similarly, when a radically polymerizable compound in an active energy ray-curable adhesive composition has an SP value close to that of a protective film (such as a triacetylcellulose (TAC) film, an acrylic film, or a cycloolefin film), the resulting adhesive layer can have high adhesion to the protective film. As a result of intensive studies based on these tendencies, the present inventors have found that the problems can be solved (I) when at least three types of radically polymerizable compounds in an active energy ray-curable adhesive composition are designed to have SP values each falling within a specific range and mixed in an optimal proportion and (II) when the active energy ray-curable adhesive composition contains an acrylic oligomer (D) formed by polymerization of a (meth)acrylic monomer. The present invention resulting from these studies has the following features to achieve the objects.

Specifically, the present invention is directed to an active energy ray-curable adhesive composition comprising radically polymerizable compounds (A), (B) and (C) as curable components, and an acrylic oligomer (D) formed by polymerization of a (meth)acrylic monomer, wherein the radically polymerizable compound (A) has an SP value of 29.0 (kJ/m³)^{1/2} to 32.0 (kJ/m³)^{1/2}; the radically polymerizable compound (B) has an SP value of 18.0 (kJ/m³)^{1/2} to less than 21.0 (kJ/m³)^{1/2}; the radically polymerizable compound (C) has an SP value of 21.0 (kJ/m³)^{1/2} to 23.0 (kJ/m³)^{1/2}; and the composition contains 25 to 80% by weight of the radically polymerizable compound (B) based on 100% by weight of the total amount of the composition.

It is important that the radically polymerizable compound (B) has an SP value of 18.0 (kJ/m³)^{1/2} to less than 21.0 (kJ/m³)^{1/2} and the content of the radically polymerizable compound (B) is from 25 to 80% by weight. The radically polymerizable compound (B), which has a relatively low SP value significantly different from that of water (47.9 in SP value), can significantly contribute to the improvement of the water resistance of the adhesive layer. The SP value of the radically polymerizable compound (B) is close to, for example, the SP value of a cyclic polyolefin resin (e.g., ZEONOR (trade name) manufactured by ZEON CORPORATION) (e.g., with an SP value of 18.6) for use as a transparent protective film. Therefore, the radically polymerizable compound (B) can contribute to the improvement of adhesion to such a transparent productive film. For further improvement of the water resistance of the adhesive layer, the radically polymerizable compound (B) preferably has an SP value of less than 20.0 (kJ/m³)^{1/2}. Particularly in view of the water resistance of the adhesive layer, the content of the radically polymerizable compound (B) is preferably 30% by weight or more, more preferably 40% by weight or more, based on 100% by weight of the total amount of the composition. On the other hand, if the content of the radically polymerizable compound (B) is too high, the content of the radically polymerizable compounds (A) and (C) must be low, so that the adhesion to the adherend will tend to decrease. In addition, if the content of the radically polymerizable compound (B) is too high, the compatibility balance between the radically polymerizable compounds can degrade, so that the transparency of the adhesive layer may decrease as phase separation proceeds, because the radically polymerizable compound (B) has an SP value significantly different from that of the radically polymerizable compound (A). In view of the adhesion to the adherend and the transparency of the adhesive layer, therefore, the content of the radically polymerizable compound (B) is preferably 75% by weight or less, more preferably 70% by weight or less, based on 100% by weight of the total amount of the composition.

In the active energy ray-curable adhesive composition according to the present invention, the radically polymerizable compound (A) has an SP value of 29.0 (kJ/m³)^{1/2} to 32.0 (kJ/m³)^{1/2}. The radically polymerizable compound (A) has a relatively high SP value and thus can contribute to the improvement of the adhesion between the adhesive layer and, for example, a PVA-based polarizer (e.g., 32.8 in SP value) or saponified triacetylcellulose (TAC; e.g., 32.7 in SP value) for use as a transparent protective film. Particularly in view of the adhesion between the adhesive layer and the polarizer and/or TAC, the content of the radically polymerizable compound (A) is preferably 3% by weight or more, more preferably 5% by weight or more, based on 100% by weight of the total amount of the composition. On the other hand, the radically polymerizable compound (A) can have low compatibility with the acrylic oligomer (D) formed by polymerization of a (meth)acrylic monomer, and may form a nonuniform adhesive layer after cured if phase separation proceeds. Thus, to ensure the uniformity and transparency of the adhesive layer, the content of the radically polymerizable compound (A) is preferably 40% by weight or less, more preferably 30% by weight or less, based on 100% by weight of the total amount of the composition.

The radically polymerizable compound (C) has an SP value of 21.0 (kJ/m³)^{1/2} to less than 23.0 (kJ/m³)^{1/2}. As mentioned above, the radically polymerizable compounds (A) and (B) have significantly different SP values and thus can have low compatibility with each other. However, the radically polymerizable compound (C) has an SP value between those of the radically polymerizable compounds (A) and (B), and thus the use of the radically polymerizable compounds (A) and (B) in combination with the radically polymerizable compound (C) can improve the compatibility between all components of the composition in a well-balanced manner. In addition, the radically polymerizable compound (C) has an SP value close to that of, for example, unsaponified triacetylcellulose (e.g., 23.3 in SP value) or an acrylic film (e.g., 22.2 in SP value) for use as a transparent protective film and thus can contribute to the improvement of the adhesion to these transparent protective films. Thus, to improve water resistance and adhesion in a well-balanced manner, the content of the radically polymerizable compound (C) is preferably from 5 to 55% by weight. In view of the compatibility between all components of the composition and the adhesion to the transparent protective film, the content of the radically polymerizable compound (C) is more preferably 10% by weight or more. In view of water resistance, the content of the radically polymerizable compound (C) is more preferably 30% by weight or less.

The active energy ray-curable adhesive composition according to the present invention contains the acrylic oligomer (D) formed by polymerization of a (meth)acrylic monomer in addition to the radically polymerizable compounds (A), (B), and (C) as curable components. The component (D) in the active energy ray-curable adhesive composition can reduce curing shrinkage when active energy rays are applied to the composition to be cured, and also can reduce interfacial stress between the adhesive and the adherend such as a polarizer or a transparent protective film. This makes it possible to suppress the reduction in the adhesion between the adhesive layer and the adherend. To suppress curing shrinkage of the cured layer (adhesive layer) sufficiently, the adhesive composition preferably contains 3% by weight or more, more preferably 5% by weight or more of the acrylic oligomer (D). On the other hand, if the content of the acrylic oligomer (D) in the adhesive composition is too high, the reaction rate may remarkably decrease upon irradiation of the composition with active energy rays, so that insufficient curing may occur. Thus, the content of the acrylic oligomer (D) in the adhesive composition is preferably 20% by weight or less, more preferably 15% by weight or less.

The active energy ray-curable adhesive composition preferably contains (E) a radically polymerizable compound having an active methylene group and (F) a radical polymerization initiator having a hydrogen-withdrawing function. This feature can provide significantly improved adhesion for the adhesive layer of a polarizing film even immediately after the polarizing film is particularly taken out of a high-humidity environment or water (undried state). Although the reason for this is not clear, the following factors can be considered. The radically polymerizable compound (E) having an active methylene group can be polymerized together with other radically polymerizable compounds used to form the adhesive layer. During the polymerization for forming the adhesive layer, the radically polymerizable compound (E) having an active methylene group can be incorporated into the main chain and/or the side chain of the base polymer in the adhesive layer. When the radical polymerization initiator (F) having a hydrogen-withdrawing function is present in this polymerization process, hydrogen can be withdrawn from the radically polymerizable compound (E) having an active methylene group so that a radical can be generated on the methylene group in the process of forming the base polymer for the adhesive layer. The radical-carrying methylene group can react with hydroxyl groups in a polarizer made of PVA or the like, so that covalent bonds can be formed between the adhesive layer and the polarizer. This may result in a significant improvement in the adhesion of the adhesive layer of the polarizing film particularly even in an undried state.

In the active energy ray-curable adhesive composition, the active methylene group is preferably an acetoacetyl group.

In the active energy ray-curable adhesive composition, the radically polymerizable compound (E) having an active methylene group is preferably acetoacetoxyalkyl (meth)acrylate.

In the active energy ray-curable adhesive composition, the radical polymerization initiator (F) is preferably a thioxanthone radical polymerization initiator.

The active energy ray-curable adhesive composition preferably contains 1 to 50% by weight of the radically polymerizable compound (E) having an active methylene group and 0.1 to 10% by weight of the radical polymerization initiator (F) based on 100% by weight of the total amount of the composition.

The active energy ray-curable adhesive composition preferably contains (G) a photo-acid generator.

In the active energy ray-curable adhesive composition, the photo-acid generator (G) preferably includes a photo-acid generator having at least one counter anion selected from the group consisting of PF₆⁻, SbF₆⁻, and AsF₆⁻.

In the active energy ray-curable adhesive composition, the photo-acid generator (G) is preferably used in combination with (H) a compound having either an alkoxy group or an epoxy group.

The active energy ray-curable adhesive composition preferably contains (I) an amino group-containing silane coupling agent. With this feature, the resulting adhesive layer can have higher adhesion in warm water. The active energy ray-curable adhesive composition preferably contains 0.01 to 20% by weight of the amino group-containing silane coupling agent (I) based on 100% by weight of the total amount of the composition.

In the active energy ray-curable adhesive composition, the radically polymerizable compounds (A), (B), and (C) are each preferably capable of forming a homopolymer with a glass transition temperature (Tg) of 60° C. or higher, so that particularly high durability can be achieved and heat shock cracking can be prevented. As used herein, the term “heat shock cracking” means a phenomenon in which, for example, as a polarizer shrinks, it tears in the stretched direction. To prevent heat shock cracking, it is important to reduce expansion and shrinkage of the polarizer in the heat shock temperature range (−40° C. to 60° C.). When the radically polymerizable compounds (A), (B), and (C) are each capable of forming a homopolymer with a glass transition temperature (Tg) of 60° C. or higher as mentioned above, the resulting adhesive layer can also have a high Tg. This can suppress a sharp change in the elastic modulus of the adhesive layer in the heat shock temperature range, and can reduce the expansion or shrinkage force on a polarizer, so that heat shock cracking can be prevented.

Hereinafter, a method for calculating the SP value (solubility parameter) in the present invention will be described below.

(Method for Calculating the Solubility Parameter (SP Value))

In the present invention, the solubility parameters (SP values) of the radically polymerizable compound, the polarizer, and various types of transparent protective films can be calculated using the Fedors method (see Polymer Eng. & Sci., Vol. 14, No. 2 (1974), pp. 148-154). Specifically, it can be calculated from the following mathematical formula:

$$δ = {[ \frac{{\sum }_{i}^{ } Δ {e}_{i}}{{\sum }_{i}^{ } Δ {v}_{i}} ]}^{1 / 2} \qquad [ Mathematical 1 ]$$

wherein Δei is the evaporation energy of an atom or group at 25° C., and Δvi is its molar volume at 25° C.

In the mathematical formula, constant values for each of i atoms and groups in the main molecule are substituted for Δei and Δvi. Table 1 below shows Δe and Δv values for typical atoms or groups.

TABLE 1

| Atom or group | Δe (J/mol) | Δv (cm³/mol) |
|---|---|---|
| CH₃ | 4086 | 33.5 |
| C | 1465 | −19.2 |
| Phenyl | 31940 | 71.4 |
| Phenylene | 31940 | 52.4 |
| COOH | 27628 | 28.5 |
| CONH₂ | 41861 | 17.5 |
| NH₂ | 12558 | 19.2 |
| —N═ | 11721 | 5.0 |
| CN | 25535 | 24.0 |
| NO₂ (fatty acid) | 29302 | 24.0 |
| NO₃ (aromatic) | 15363 | 32.0 |
| O | 3349 | 3.8 |
| OH | 29805 | 10.0 |
| S | 14149 | 12.0 |
| F | 4186 | 18.0 |
| Cl | 11553 | 24.0 |
| Br | 15488 | 30.0 |

In the active energy ray-curable adhesive composition, the total content of the radically polymerizable compounds (A), (B) and (C), and the acrylic oligomer (D) formed by polymerization of a (meth)acrylic monomer is preferably from 70 to 100 parts by weight based on 100 parts by weight of the total amount of the radically polymerizable compounds. According to this feature, the adhesive composition can have satisfactory contents of the radically polymerizable compounds (A), (B) and (C), and the acrylic oligomer (D), so that the resulting adhesive layer can have a higher level of adhesion, durability, and water resistance. For the purpose of further improving adhesion, durability, and water resistance in a well-balanced manner, the total content of the radically polymerizable compounds (A), (B) and (C), and the acrylic oligomer (D) is preferably from 80 to 100 parts by weight, more preferably from 90 to 100 parts by weight.

In the active energy ray-curable adhesive composition, the radically polymerizable compound (A) is preferably hydroxyethylacrylamide and/or N-methylolacrylamide. In the active energy ray-curable adhesive composition, the radically polymerizable compound (B) is preferably tripropylene glycol diacrylate. In the active energy ray-curable adhesive composition, the radically polymerizable compound (C) is preferably acryloylmorpholine and/or N-methoxymethylacrylamide. According to these features, the adhesion, durability, and water resistance of the adhesive layer can be improved in a better-balanced manner.

The active energy ray-curable adhesive composition preferably contains, as a photopolymerization initiator, a compound represented by formula (1):

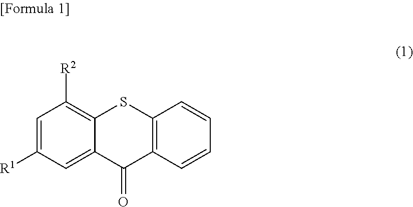

wherein R¹ and R² each represent —H, —CH₂CH₃, —IPR, or Cl, and R¹ and R² may be the same or different.

The photopolymerization initiator of formula (1) can initiate polymerization with long-wavelength light capable of passing through a transparent protective film having the ability to absorb UV. Thus, the photopolymerization initiator of formula (1) makes it possible to cure the adhesive composition with light through an ultraviolet-absorbing film. Specifically, for example, when containing the photopolymerization initiator of formula (1), the adhesive composition can be cured even in a laminate having UV-absorbing transparent protective films provided on both sides, such as a laminate of triacetylcellulose/polarizer/triacetylcellulose.

In addition to the photopolymerization initiator of formula (1), the active energy ray-curable adhesive composition also preferably contains, as a photopolymerization initiator, a compound represented by formula (2):

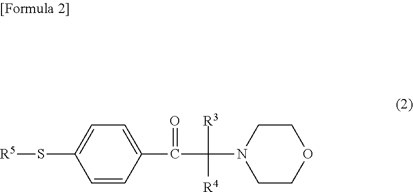

wherein R³, R⁴, and R⁵ each represent —H, —CH₃, —CH₂CH₃, —IPR, or Cl, and R³, R⁴, and R⁵ may be the same or different. The use of a combination of the photopolymerization initiators of formulae (1) and (2) can particularly increase the adhesion of the adhesive layer because these materials can cause a photosensitizing reaction to increase the reaction efficiency.

The present invention is also directed to a polarizing film, including: a polarizer; an adhesive layer; and a transparent protective film provided on at least one surface of the polarizer with the adhesive layer interposed therebetween, wherein the transparent protective film has a transmittance of less than 5% for light with a wavelength of 365 nm, and the adhesive layer is made of a cured material obtained by applying active energy rays to the active energy ray-curable adhesive composition having any of the above features.

As mentioned above, the polarizer has a relatively high SP value (for example, a PVA-based polarizer has an SP value of 32.8), whereas the transparent protective film usually has a relatively low SP value (about 18 to 24 in SP value). The polarizing film according to the present invention is so designed that the polarizer with a relatively high SP value and the transparent protective film with a relatively low SP value are bonded with an adhesive layer made from the active energy ray-curable adhesive composition including the radically polymerizable compounds (A), (B), and (C) and the acrylic oligomer (D) formed by polymerization of a (meth)acrylic monomer in which the SP values and contents of the compounds (A), (B), and (C) and the oligomer (D) are optimized. In the polarizing film, therefore, the polarizer and the transparent protective film are strongly bonded with the adhesive layer having a high level of durability and water resistance. In particular, when the adhesive layer has a Tg of 60° C. or higher, preferably 70° C. or higher, more preferably 90° C. or higher, particularly high durability is achieved, and heat shock cracking is successfully prevented.

In the polarizing film, the transparent protective film preferably has a water-vapor permeability of 150 g/m²/24 hours or less. According to this feature, moisture in the air hardly enters the polarizing film, and the polarizing film itself can be prevented from changing in water content. Therefore, storage environment-induced curling or dimensional change of the polarizing film can be prevented.

In the polarizing film, the transparent protective film preferably has an SP value of 29.0 (kJ/m³)^{1/2} to less than 33.0 (kJ/m³)^{1/2}. When the transparent protective film has an SP value in this range, the adhesion between the transparent protective film and the adhesive layer can be significantly improved because its SP value is very close to the SP value of the radically polymerizable compound (A) in the active energy ray-curable adhesive composition. The transparent protective film with an SP value of 29.0 (kJ/m³)^{1/2} to less than 33.0 (kJ/m³)^{1/2} may be made of, for example, saponified triacetylcellulose (e.g., with an SP value of 32.7).

In the polarizing film, the transparent protective film preferably has an SP value of 18.0 (kJ/m³)^{1/2} to less than 24.0 (kJ/m³)^{1/2}. When the transparent protective film has an SP value in this range, the adhesion between the transparent protective film and the adhesive layer can be significantly improved because its SP value is very close to the SP value of the radically polymerizable compounds (B) and (C) in the active energy ray-curable adhesive composition. The transparent protective film with an SP value of 18.0 (kJ/m³)^{1/2} to less than 24.0 (kJ/m³)^{1/2} may be made of, for example, unsaponified triacetylcellulose (e.g., with an SP value of 23.3).

The present invention is also directed to a method for manufacturing a polarizing film including a polarizer, a transparent protective film provided on at least one surface of the polarizer and having a transmittance of less than 5% for light with a wavelength of 365 nm, and an adhesive layer interposed between the polarizer and the transparent protective film, the method including: an application step including applying the active energy ray-curable adhesive composition having any of the above features to the surface of at least one of the polarizer and the transparent protective film; a lamination step including laminating the polarizer and the transparent protective film; and a bonding step including curing the active energy ray-curable adhesive composition by applying active energy rays to the composition from the polarizer side or the transparent protective film side to form an adhesive layer, so that the polarizer and the transparent protective film are bonded with the adhesive layer interposed therebetween. This manufacturing method can produce a polarizing film having a polarizer and a transparent protective film bonded together with an adhesive layer having good adhesion thereto and a high level of durability and water resistance.

In the polarizing film-manufacturing method, the surface (on the side to be bonded) of at least one of the polarizer and the transparent protective film is preferably subjected to a corona treatment, a plasma treatment, an excimer treatment, or a flame treatment before the application step.

In the polarizing film-manufacturing method, the polarizing film preferably includes a polarizer, transparent protective films provided on both sides of the polarizer and each having a transmittance of less than 5% for light with a wavelength of 365 nm, and adhesive layers each interposed between the polarizer and the transparent protective film, and the bonding step preferably includes curing the active energy ray-curable adhesive composition by first applying active energy rays to the composition from one transparent productive film side and then applying active energy rays to the composition from another transparent protective film side to form adhesive layers, so that the polarizer and the transparent protective films are bonded with the adhesive layers interposed therebetween.

In the polarizing film-manufacturing method, the active energy rays preferably include visible rays with a wavelength ranging from 380 nm to 450 nm.

In the polarizing film-manufacturing method, the active energy rays are preferably such that the ratio of the total illuminance in the wavelength range of 380 nm to 440 nm to the total illuminance in the wavelength range of 250 nm to 370 nm is from 100:0 to 100:50.

In the polarizing film-manufacturing method, the polarizer preferably has a water content of less than 15% during the lamination step. This manufacturing method makes it possible to reduce the intensity of drying of the polarizing film obtained after the lamination step (lamination) and to produce a polarizing film having a polarizer and a transparent protective film bonded together with an adhesive layer having good adhesion and a high level of durability and water resistance.

The present invention is also directed to an optical film including a laminate including at least one piece of the polarizing plate set forth above.

The present invention is also directed to an image display device including the polarizing film set forth above and/or the optical film set forth above. In the optical film or the image display device, the polarizer and the transparent protective film in the polarizing film are strongly bonded together with the adhesive layer interposed therebetween, and the adhesive layer has a high level of durability and water resistance.

### Effect of the Invention

When cured, the active energy ray-curable adhesive composition according to the present invention can form an adhesive layer having higher adhesion to two or more members, specifically, higher adhesion to a polarizer and a transparent protective film, and also having a higher level of durability and water resistance. In the polarizing film according to the present invention, the adhesive layer has good adhesion between the polarizer and the transparent protective film, even when the polarizer used has a low water content, and the adhesive layer also has a high level of durability and water resistance.

When the adhesive layer according to the present invention used, polarizing films resistant to dimensional changes can be produced. This makes it possible to easily address the production of large-sized polarizing films and to reduce manufacturing cost in terms of yield or the number of available pieces. The polarizing film according to the present invention also has high dimensional stability, which helps to prevent external heat from a backlight from causing unevenness in image display devices.

### MODE FOR CARRYING OUT THE INVENTION

The active energy ray-curable adhesive composition according to the present invention includes (A) a radically polymerizable compound with an SP value of 29.0 (kJ/m³)^{1/2} to 32.0 (kJ/m³)^{1/2} as a curable component, (B) a radically polymerizable compound with an SP value of 18.0 (kJ/m³)^{1/2} to less than 21.0 (kJ/m³)^{1/2} as a curable component, (C) a radically polymerizable compound with an SP value of 21.0 (kJ/m³)^{1/2} to 23.0 (kJ/m³)^{1/2} as a curable component, and (D) an acrylic oligomer formed by polymerization of a (meth)acrylic monomer. The active energy ray-curable adhesive composition according to the present invention contains 25 to 80% by weight of the radically polymerizable compound (B) based on 100% by weight of the total amount of the composition. As used herein, the term “the total amount of the composition” means the amount of all the components, which may include not only the radically polymerizable compounds but also any of various initiators and additives.

The radically polymerizable compound (A) may be any compound having a radically polymerizable group such as a (meth)acrylate group and having an SP value of 29.0 (kJ/m³)^{1/2} to 32.0 (kJ/m³)^{1/2}. Examples of the radically polymerizable compound (A) include hydroxyethylacrylamide (29.6 in SP value) and N-methylolacrylamide (31.5 in SP value). As used herein, the term “(meth)acrylate group” means an acrylate group and/or a methacrylate group.

The radically polymerizable compound (B) may be any compound having a radically polymerizable group such as a (meth)acrylate group and having an SP value of 18.0 (kJ/m³)^{1/2} to less than 21.0 (kJ/m³)^{1/2}. Examples of the radically polymerizable compound (B) include tripropylene glycol diacrylate (19.0 in SP value), 1,9-nonanediol diacrylate (19.2 in SP value), tricyclodecane dimethanol diacrylate (20.3 in SP value), cyclic trimethylolpropane formal acrylate (19.1 in SP value), dioxane glycol diacrylate (19.4 in SP value), and EO-modified diglycerol tetraacrylate (20.9 in SP value). The radically polymerizable compound (B) may be advantageously a commercially available product, examples of which include Aronix M-220 (manufactured by Toagosei Co., Ltd., 19.0 in SP value), LIGHT ACRYLATE 1.9ND-A (manufactured by Kyoeisha Chemical Co., Ltd., 19.2 in SP value), LIGHT ACRYLATE DGE-4A (manufactured by Kyoeisha Chemical Co., Ltd., 20.9 in SP value), LIGHT ACRYLATE DCP-A (manufactured by Kyoeisha Chemical Co., Ltd., 20.3 in SP value), SR-531 (manufactured by Sartomer, 19.1 in SP value), and CD-536 (manufactured by Sartomer, 19.4 in SP value).

The radically polymerizable compound (C) may be any compound having a radically polymerizable group such as a (meth)acrylate group and having an SP value of 21.0 (kJ/m³)^{1/2} to 23.0 (kJ/m³)^{1/2}. Examples of the radically polymerizable compound (C) include acryloylmorpholine (22.9 in SP value), N-methoxymethylacrylamide (22.9 in SP value), and N-ethoxymethylacrylamide (22.3 in SP value). The radically polymerizable compound (C) may be advantageously a commercially available product, examples of which include ACMO (manufactured by KOHJIN Film & Chemicals Co., Ltd., 22.9 in SP value), WASMER 2MA (manufactured by Kasano Kosan Co., Ltd., 22.9 in SP value), WASMER EMA (manufactured by Kasano Kosan Co., Ltd., 22.3 in SP value), and WASMER 3MA (manufactured by Kasano Kosan Co., Ltd., 22.4 in SP value).

When the radically polymerizable compounds (A), (B), and (C) are each capable of forming a homopolymer with a glass transition temperature (Tg) of 60° C. or more, the resulting adhesive layer can also have a high Tg and particularly high durability. This makes it possible to prevent heat shock cracking of a polarizer, for example, when the compounds are used to form an adhesive layer between the polarizer and a transparent protective film. Herein, the Tg of a homopolymer of the radically polymerizable compound means the Tg of a product that can be obtained by curing (polymerizing) the radically polymerizable compound alone. How to measure the Tg will be described below.

In view of workability or uniformity during coating, the active energy ray-curable adhesive composition preferably has low viscosity. Therefore, the acrylic oligomer (D) formed by polymerization of a (meth)acrylic monomer also preferably has low viscosity. The acrylic oligomer that has low viscosity and can prevent curing shrinkage of the adhesive layer preferably has a weight average molecular weight (Mw) of 15,000 or less, more preferably 10,000 or less, even more preferably 5,000 or less. On the other hand, to suppress curing shrinkage of the cured layer (adhesive layer) sufficiently, the acrylic oligomer (D) preferably has a weight average molecular weight (Mw) of 500 or more, more preferably 1,000 or more, even more preferably 1,500 or more. Examples of the (meth)acrylic monomer used to form the acrylic oligomer (D) include (C1 to C20) alkyl (meth)acrylates such as methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, sec-butyl (meth)acrylate, tert-butyl (meth)acrylate, n-pentyl (meth)acrylate, tert-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, and n-octadecyl (meth)acrylate; cycloalkyl (meth)acrylates (e.g., cyclohexyl (meth)acrylate and cyclopentyl (meth)acrylate); aralkyl (meth)acrylates (e.g., benzyl (meth)acrylate); polycyclic (meth)acrylates (e.g., 2-isobornyl (meth)acrylate, 2-norbornylmethyl (meth)acrylate, 5-norbornen-2-yl-methyl (meth)acrylate, and 3-methyl-2-norbornylmethyl (meth)acrylate); hydroxyl group-containing (meth)acrylates (e.g., hydroxyethyl (meth)acrylate, 2-hydroxypropyl (meth)acrylate, and 2,3-dihydroxypropylmethyl-butyl (meth)acrylate); alkoxy group- or phenoxy group-containing (meth)acrylates (e.g., 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate); epoxy group-containing (meth)acrylates (e.g., glycidyl (meth)acrylate); halogen-containing (meth)acrylates (e.g., 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate); and alkylaminoalkyl (meth)acrylates (e.g., dimethylaminoethyl (meth)acrylate). These (meth)acrylates may be used singly or in combination of two or more. Examples of the acrylic oligomer (D) include ARUFON manufactured by Toagosei Co., Ltd., Actflow manufactured by Soken Chemical & Engineering Co., Ltd., and JONCRYL manufactured by BASF Japan Ltd.

The active energy ray-curable adhesive composition preferably further contains (E) a radically polymerizable compound having an active methylene group and (F) a radical polymerization initiator having a hydrogen-withdrawing function.

The radically polymerizable compound (E) having an active methylene group should be a compound having an active double-bond group such as a (meth)acrylic group at its end or in its molecule and also having an active methylene group. The active methylene group may be, for example, an acetoacetyl group, an alkoxymalonyl group, or a cyanoacetyl group. Examples of the radically polymerizable compound (E) having an active methylene group include acetoacetoxyalkyl (meth)acrylates such as 2-acetoacetoxyethyl (meth)acrylate, 2-acetoacetoxypropyl (meth)acrylate, and 2-acetoacetoxy-1-methylethyl (meth)acrylate; 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radically polymerizable compound (E) having an active methylene group may have any SP value.

In the present invention, the radical polymerization initiator (F) having a hydrogen-withdrawing function may be, for example, a thioxanthone radical polymerization initiator or a benzophenone radical polymerization initiator. The thioxanthone radical polymerization initiator may be, for example, the compound of formula (1) shown above. Examples of the compound of formula (1) include thioxanthone, dimethyl thioxanthone, diethyl thioxanthone, isopropyl thioxanthone, and chlorothioxanthone. In particular, the compound of formula (1) is preferably diethyl thioxanthone in which R¹ and R² are each —CH₂CH₃.

In the present invention, as described above, the reaction of the radically polymerizable compound (E) having an active methylene group in the presence of the radical polymerization initiator (F) having a hydrogen-withdrawing function produces a radical on the methylene group, which reacts with the hydroxyl group in a polarizer made of PVA or the like to form a covalent bond. Thus, to produce a radical on the methylene group of the radically polymerizable compound (E) having an active methylene group so that the covalent bond can be sufficiently formed, the composition preferably contains 1 to 50% by weight of the radically polymerizable compound (E) having an active methylene group and 0.1 to 10% by weight of the radical polymerization initiator (F), and more preferably contains 3 to 30% by weight of the radically polymerizable compound (E) having an active methylene group and 0.3 to 9% by weight of the radical polymerization initiator (F), based on 100% by weight of the total amount of the composition. If the content of the radically polymerizable compound (E) having an active methylene group is less than 1% by weight, the effect of increasing the adhesion in an undried state can be low, and water resistance may fail to improve sufficiently. If it is more than 50% by weight, the adhesive layer may be insufficiently cured. If the content of the radical polymerization initiator (F) having a hydrogen-withdrawing function is less than 0.1% by weight, the hydrogen-withdrawing reaction may fail to proceed sufficiently. If it is more than 10% by weight, the initiator (F) may fail to dissolve completely in the composition.

In the present invention, the active energy ray-curable adhesive composition may contain a photo-acid generator. In this case, the resulting adhesive layer can have a significantly higher level of water resistance and durability than that in the case where the composition contains no photo-acid generator. The photo-acid generator (G) may be represented by general formula (3) below.

General formula (3):

L⁺ X⁻ [Formula 3]

wherein L⁺ represents any onium cation, and X⁻ represents a counter anion selected from the group consisting of PF₆⁻, SbF₆⁻, AsF₆⁻, SbCl₆⁻, BiCl₅⁻, SnCl₆⁻, ClO₄⁻, dithiocarbamate anion, and SCN⁻.

A preferred onium cation structure of the onium cation L⁺ in general formula (3) is selected from those of general formulae (4) to (12) below.

General formula (4):

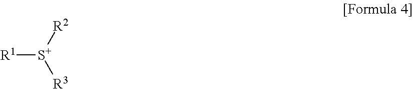

General formula (5):

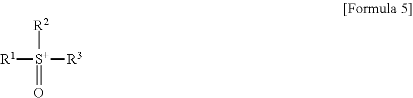

General formula (6):

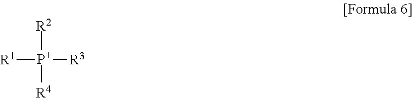

General formula (7):

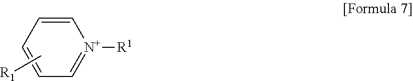

General formula (8):

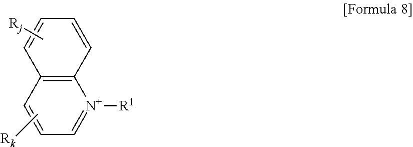

General formula (9):

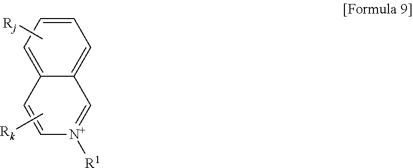

General formula (10):

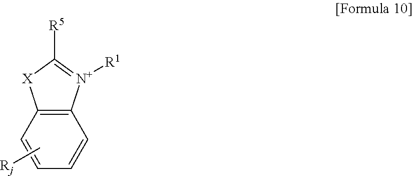

General formula (11):

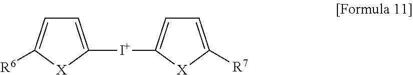

General formula (12):

Ar⁴—I⁺—Ar⁵ [Formula 12]

In General formulae (4) to (12), R¹, R², and R³ each independently represent a group selected from a hydrogen atom, a substituted or unsubstituted alkyl group, a substituted or unsubstituted alkenyl group, a substituted or unsubstituted aryl group, a substituted or unsubstituted heterocyclic group, a substituted or unsubstituted alkoxyl group, a substituted or unsubstituted aryloxy group, a substituted or unsubstituted heterocyclic oxy group, a substituted or unsubstituted acyl group, a substituted or unsubstituted carbonyloxy group, a substituted or unsubstituted oxycarbonyl group, or a halogen atom, R⁴ has the same meaning as defined for R¹, R², and R³, R⁵ represents a substituted or unsubstituted alkyl group or a substituted or unsubstituted alkylthio group, R⁶ and R⁷ each independently represent a substituted or unsubstituted alkyl group or a substituted or unsubstituted alkoxyl group, R represents a halogen atom, a hydroxyl group, a carboxyl group, a mercapto group, a cyano group, a nitro group, a substituted or unsubstituted carbamoyl group, a substituted or unsubstituted alkyl group, a substituted or unsubstituted alkenyl group, a substituted or unsubstituted aryl group, a substituted or unsubstituted heterocyclic group, a substituted or unsubstituted alkoxyl group, a substituted or unsubstituted aryloxy group, a substituted or unsubstituted heterocyclic oxy group, a substituted or unsubstituted alkylthio group, a substituted or unsubstituted arylthio group, a substituted or unsubstituted heterocyclic thio group, a substituted or unsubstituted acyl group, a substituted or unsubstituted carbonyloxy group, or a substituted or unsubstituted oxycarbonyl group, Ar⁴ and Ar⁵ each represent a substituted or unsubstituted aryl group or a substituted or unsubstituted heterocyclic group, X represents an oxygen or sulfur atom, i represents an integer of 0 to 5, j represents an integer of 0 to 4, k represents an integer of 0 to 3, and adjacent R moieties, Ar⁴ and Ar⁵, R² and R³, R² and R⁴, R³ and R⁴, R¹ and R², R¹ and R³, R¹ and R⁴, R¹ and R, or R¹ and R⁵ may be linked together to form a cyclic structure.

Examples of the onium cation (sulfonium cation) corresponding to general formula (4) include, but are not limited to, dimethyl phenyl sulfonium, dimethyl(o-fluorophenyl)sulfonium, dimethyl(m-chlorophenyl)sulfonium, dimethyl(p-bromophenyl)sulfonium, dimethyl(p-cyanophenyl)sulfonium, dimethyl(m-nitrophenyl)sulfonium, dimethyl(2,4,6-tribromophenyl)sulfonium, dimethyl(pentafluorophenyl)sulfonium, dimethyl(p-(trifluoromethyl)phenyl)sulfonium, dimethyl(p-hydroxyphenyl)sulfonium, dimethyl(p-mercaptophenyl)sulfonium, dimethyl(p-methylsulfinylphenyl)sulfonium, dimethyl(p-methylsulfonylphenyl)sulfonium, dimethyl(o-acetylphenyl)sulfonium, dimethyl(o-benzoylphenyl)sulfonium, dimethyl(p-methylphenyl)sulfonium, dimethyl(p-isopropylphenyl)sulfonium, dimethyl(p-octadecylphenyl)sulfonium, dimethyl(p-cyclohexylphenyl)sulfonium, dimethyl(p-methoxyphenyl)sulfonium, dimethyl(o-methoxycarbonylphenyl)sulfonium, dimethyl(p-phenylsulfanylphenyl)sulfonium, (7-methoxy-2-oxo-2H-chromen-4-yl)dimethyl sulfonium, (4-methoxynaphthalene-1-yl)dimethyl sulfonium, dimethyl(p-isopropoxycarbonylphenyl)sulfonium, dimethyl(2-naphthyl)sulfonium, dimethyl(9-anthryl)sulfonium, diethyl phenyl sulfonium, methyl ethyl phenyl sulfonium, methyl diphenyl sulfonium, triphenyl sulfonium, diisopropyl phenyl sulfonium, diphenyl(4-phenylsulfanyl-phenyl)-sulfonium, 4,4′-bis(diphenyl sulfonium)diphenyl sulfide, 4,4′-bis[di[(4-(2-hydroxy-ethoxy)-phenyl)]sulfonium]]diphen yl sulfide, 4,4′-bis(diphenyl sulfonium)biphenylene, diphenyl(o-fluorophenyl)sulfonium, diphenyl(m-chlorophenyl)sulfonium, diphenyl(p-bromophenyl)sulfonium, diphenyl(p-cyanophenyl)sulfonium, diphenyl(m-nitrophenyl)sulfonium, diphenyl(2,4,6-tribromophenyl)sulfonium, diphenyl(pentafluorophenyl)sulfonium, diphenyl(p-(trifluoromethyl)phenyl)sulfonium, diphenyl(p-hydroxyphenyl)sulfonium, diphenyl(p-mercaptophenyl)sulfonium, diphenyl(p-methylsulfinylphenyl)sulfonium, diphenyl(p-methylsulfonylphenyl)sulfonium, diphenyl(o-acetylphenyl)sulfonium, diphenyl(o-benzoylphenyl)sulfonium, diphenyl(p-methylphenyl)sulfonium, diphenyl(p-isopropylphenyl)sulfonium, diphenyl(p-octadecylphenyl)sulfonium, diphenyl(p-cyclohexylphenyl)sulfonium, diphenyl(p-methoxyphenyl)sulfonium, diphenyl(o-methoxycarbonylphenyl)sulfonium, diphenyl(p-phenylsulfanylphenyl)sulfonium, (7-methoxy-2-oxo-2H-chromen-4-yl)diphenyl sulfonium, (4-methoxynaphthalene-1-yl)diphenyl sulfonium, diphenyl(p-isopropoxycarbonylphenyl)sulfonium, diphenyl(2-naphthyl)sulfonium, diphenyl(9-anthryl)sulfonium, ethyl diphenyl sulfonium, methyl ethyl (o-tolyl)sulfonium, methyl di(p-tolyl)sulfonium, tri(p-tolyl)sulfonium, diisopropyl(4-phenylsulfanylphenyl)sulfonium, diphenyl(2-thienyl)sulfonium, diphenyl(2-furyl)sulfonium, and diphenyl(9-ethyl-9H-carbazol-3-yl)sulfonium.

Examples of the onium cation (sulfoxonium cation) corresponding to general formula (5) include, but are not limited to, dimethyl phenyl sulfoxonium, dimethyl(o-fluorophenyl)sulfoxonium, dimethyl(m-chlorophenyl)sulfoxonium, dimethyl(p-bromophenyl)sulfoxonium, dimethyl(p-cyanophenyl)sulfoxonium, dimethyl(m-nitrophenyl)sulfoxonium, dimethyl(2,4,6-tribromophenyl)sulfoxonium, dimethyl(pentafluorophenyl)sulfoxonium, dimethyl(p-(trifluoromethyl)phenyl)sulfoxonium, dimethyl(p-hydroxyphenyl)sulfoxonium, dimethyl(p-mercaptophenyl)sulfoxonium, dimethyl(p-methylsulfinylphenyl)sulfoxonium, dimethyl(p-methylsulfonylphenyl)sulfoxonium, dimethyl(o-acetylphenyl)sulfoxonium, dimethyl(o-benzoylphenyl)sulfoxonium, dimethyl(p-methylphenyl)sulfoxonium, dimethyl(p-isopropylphenyl)sulfoxonium, dimethyl(p-octadecylphenyl)sulfoxonium, dimethyl(p-cyclohexylphenyl)sulfoxonium, dimethyl(p-methoxyphenyl)sulfoxonium, dimethyl(o-methoxycarbonylphenyl)sulfoxonium, dimethyl(p-phenylsulfanylphenyl)sulfoxonium, (7-methoxy-2-oxo-2H-chromen-4-yl)dimethyl sulfoxonium, (4-methoxynaphthalene-1-yl)dimethyl sulfoxonium, dimethyl(p-isopropoxycarbonylphenyl)sulfoxonium, dimethyl(2-naphthyl)sulfoxonium, dimethyl(9-anthryl)sulfoxonium, diethyl phenyl sulfoxonium, methyl ethyl phenyl sulfoxonium, methyl diphenyl sulfoxonium, triphenyl sulfoxonium, diisopropyl phenyl sulfoxonium, diphenyl(4-phenylsulfanyl-phenyl)-sulfoxonium, 4,4′-bis(diphenyl sulfoxonium)diphenyl sulfide, 4,4′-bis[di[(4-(2-hydroxy-ethoxy)-phenyl)]sulfoxonium]]diphenyl sulfide, 4,4′-bis(diphenyl sulfoxonium)biphenylene, diphenyl(o-fluorophenyl)sulfoxonium, diphenyl(m-chlorophenyl)sulfoxonium, diphenyl(p-bromophenyl)sulfoxonium, diphenyl(p-cyanophenyl)sulfoxonium, diphenyl(m-nitrophenyl)sulfoxonium, diphenyl(2,4,6-tribromophenyl)sulfoxonium, diphenyl(pentafluorophenyl)sulfoxonium, diphenyl(p-(trifluoromethyl)phenyl)sulfoxonium, diphenyl(p-hydroxyphenyl)sulfoxonium, diphenyl(p-mercaptophenyl)sulfoxonium, diphenyl(p-methylsulfinylphenyl)sulfoxonium, diphenyl(p-methylsulfonylphenyl)sulfoxonium, diphenyl(o-acetylphenyl)sulfoxonium, diphenyl(o-benzoylphenyl)sulfoxonium, diphenyl(p-methylphenyl)sulfoxonium, diphenyl(p-isopropylphenyl)sulfoxonium, diphenyl(p-octadecylphenyl)sulfoxonium, diphenyl(p-cyclohexylphenyl)sulfoxonium, diphenyl(p-methoxyphenyl)sulfoxonium, diphenyl(o-methoxycarbonylphenyl)sulfoxonium, diphenyl(p-phenylsulfanylphenyl)sulfoxonium, (7-methoxy-2-oxo-2H-chromen-4-yl)diphenyl sulfoxonium, (4-methoxynaphthalene-1-yl)diphenyl sulfoxonium, diphenyl(p-isopropoxycarbonylphenyl)sulfoxonium, diphenyl(2-naphthyl)sulfoxonium, diphenyl(9-anthryl)sulfoxonium, ethyl diphenyl sulfoxonium, methyl ethyl (o-tolyl)sulfoxonium, methyl di(p-tolyl)sulfoxonium, tri(p-tolyl)sulfoxonium, diisopropyl(4-phenylsulfanylphenyl)sulfoxonium, diphenyl(2-thienyl)sulfoxonium, diphenyl(2-furyl)sulfoxonium, and diphenyl(9-ethyl-9H-carbazol-3-yl)sulfoxonium.

Examples of the onium cation (phosphonium cation) corresponding to general formula (6) include, but are not limited to, trimethyl phenyl phosphonium, triethyl phenyl phosphonium, tetraphenyl phosphonium, triphenyl(p-fluorophenyl)phosphonium, triphenyl(o-chlorophenyl)phosphonium, triphenyl(m-bromophenyl)phosphonium, triphenyl(p-cyanophenyl)phosphonium, triphenyl(m-nitrophenyl)phosphonium, triphenyl(p-phenylsulfanylphenyl)phosphonium, (7-methoxy-2-oxo-2H-chromen-4-yl)triphenyl phosphonium, triphenyl(o-hydroxyphenyl)phosphonium, triphenyl(o-acetylphenyl)phosphonium, triphenyl(m-benzoylphenyl)phosphonium, triphenyl(p-methylphenyl)phosphonium, triphenyl(p-isopropoxyphenyl)phosphonium, triphenyl(o-methoxycarbonylphenyl)phosphonium, triphenyl(1-naphthyl)phosphonium, triphenyl(9-anthryl)phosphonium, triphenyl(2-thienyl)phosphonium, triphenyl(2-furyl)phosphonium, and triphenyl(9-ethyl-9H-carbazol-3-yl)phosphonium.

Examples of the onium cation (pyridinium cation) corresponding to general formula (7) include, but are not limited to, N-phenylpyridinium, N-(o-chlorophenyl)pyridinium, N-(m-chlorophenyl)pyridinium, N-(p-cyanophenyl)pyridinium, N-(o-nitrophenyl)pyridinium, N-(p-acetylphenyl)pyridinium, N-(p-isopropylphenyl)pyridinium, N-(p-octadecyloxyphenyl)pyridinium, N-(p-methoxycarbonylphenyl)pyridinium, N-(9-anthryl)pyridinium, 2-chloro-1-phenylpyridinium, 2-cyano-1-phenylpyridinium, 2-methyl-1-phenylpyridinium, 2-vinyl-1-phenylpyridinium, 2-phenyl-1-phenylpyridinium, 1,2-diphenylpyridinium, 2-methoxy-1-phenylpyridinium, 2-phenoxy-1-phenylpyridinium, 2-acetyl-1-(p-tolyl)pyridinium, 2-methoxycarbonyl-1-(p-tolyl)pyridinium, 3-fluoro-1-naphthylpyridinium, 4-methyl-1-(2-furyl)pyridinium, N-methylpyridinium, and N-ethylpyridinium.

Examples of the onium cation (quinolinium cation) corresponding to general formula (8) include, but are not limited to, N-methylquinolinium, N-ethylquinolinium, N-phenylquinolinium, N-naphthylquinolinium, N-(o-chlorophenyl)quinolinium, N-(m-chlorophenyl)quinolinium, N-(p-cyanophenyl)quinolinium, N-(o-nitrophenyl)quinolinium, N-(p-acetylphenyl)quinolinium, N-(p-isopropylphenyl)quinolinium, N-(p-octadecyloxyphenyl)quinolinium, N-(p-methoxycarbonylphenyl)quinolinium, N-(9-anthryl)quinolinium, 2-chloro-1-phenylquinolinium, 2-cyano-1-phenylquinolinium, 2-methyl-1-phenylquinolinium, 2-vinyl-1-phenylquinolinium, 2-phenyl-1-phenylquinolinium, 1,2-diphenylquinolinium, 2-methoxy-1-phenylquinolinium, 2-phenoxy-1-phenylquinolinium, 2-acetyl-1-phenylquinolinium, 2-methoxycarbonyl-1-phenylquinolinium, 3-fluoro-1-phenylquinolinium, 4-methyl-1-phenylquinolinium, 2-methoxy-1-(p-tolyl)quinolinium, 2-phenoxy-1-(2-furyl)quinolinium, 2-acetyl-1-(2-thienyl)quinolinium, 2-methoxycarbonyl-1-methylquinolinium, 3-fluoro-1-ethylquinolinium, and 4-methyl-1-isopropylquinolinium.

Examples of the onium cation (isoquinolinium cation) corresponding to general formula (9) include, but are not limited to, N-phenylisoquinolinium, N-methylisoquinolinium, N-ethylisoquinolinium, N-(o-chlorophenyl)isoquinolinium, N-(m-chlorophenyl)isoquinolinium, N-(p-cyanophenyl)isoquinolinium, N-(o-nitrophenyl)isoquinolinium, N-(p-acetylphenyl)isoquinolinium, N-(p-isopropylphenyl)isoquinolinium, N-(p-octadecyloxyphenyl)isoquinolinium, N-(p-methoxycarbonylphenyl)isoquinolinium, N-(9-anthryl)isoquinolinium, 1,2-diphenylisoquinolinium, N-(2-furyl)isoquinolinium, N-(2-thienyl)isoquinolinium, and N-naphthylisoquinolinium.

Examples of the onium cation (benzoxazolium cation) corresponding to general formula (10) include, but are not limited to, N-methylbenzoxazolium, N-ethylbenzoxazolium, N-naphthylbenzoxazolium, N-phenylbenzoxazolium, N-(p-fluorophenyl)benzoxazolium, N-(p-chlorophenyl)benzoxazolium, N-(p-cyanophenyl)benzoxazolium, N-(o-methoxycarbonylphenyl)benzoxazolium, N-(2-furyl)benzoxazolium, N-(o-fluorophenyl)benzoxazolium, N-(p-cyanophenyl)benzoxazolium, N-(m-nitrophenyl)benzoxazolium, N-(p-isopropoxycarbonylphenyl)benzoxazolium, N-(2-thienyl)benzoxazolium, N-(m-carboxyphenyl)benzoxazolium, 2-mercapto-3-phenylbenzoxazolium, 2-methyl-3-phenylbenzoxazolium, 2-methylthio-3-(4-phenylsulfanylphenyl)benzoxazolium, 6-hydroxy-3-(p-tolyl)benzoxazolium, 7-mercapto-3-phenylbenzoxazolium, and 4,5-difluoro-3-ethylbenzoxazolium.

Examples of benzothiazolium cation, but are not limited to, N-methylbenzothiazolium, N-ethylbenzothiazolium, N-phenylbenzothiazolium, N-(1-naphthyl)benzothiazolium, N-(p-fluorophenyl)benzothiazolium, N-(p-chlorophenyl)benzothiazolium, N-(p-cyanophenyl)benzothiazolium, N-(o-methoxycarbonylphenyl)benzothiazolium, N-(p-tolyl)benzothiazolium, N-(o-fluorophenyl)benzothiazolium, N-(m-nitrophenyl)benzothiazolium, N-(p-isopropoxycarbonylphenyl)benzothiazolium, N-(2-furyl)benzothiazolium, N-(4-methylthiophenyl)benzothiazolium, N-(4-phenylsulfanylphenyl)benzothiazolium, N-(2-naphthyl)benzothiazolium, N-(m-carboxyphenyl)benzothiazolium, 2-mercapto-3-phenylbenzothiazolium, 2-methyl-3-phenylbenzothiazolium, 2-methylthio-3-phenylbenzothiazolium, 6-hydroxy-3-phenylbenzothiazolium, 7-mercapto-3-phenylbenzothiazolium, and 4,5-difluoro-3-phenylbenzothiazolium.

Examples of the onium cation (furyl- or thienyl-iodonium cation) corresponding to general formula (11) include, but are not limited to, difuryliodonium, dithienyliodonium, bis(4,5-dimethyl-2-furyl)iodonium, bis(5-chloro-2-thienyl)iodonium, bis(5-cyano-2-furyl)iodonium, bis(5-nitro-2-thienyl)iodonium, bis(5-acetyl-2-furyl)iodonium, bis(5-carboxy-2-thienyl)iodonium, bis(5-methoxycarbonyl-2-furyl)iodonium, bis(5-phenyl-2-furyl)iodonium, bis(5-(p-methoxyphenyl)-2-thienyl)iodonium, bis(5-vinyl-2-furyl)iodonium, bis(5-ethynyl-2-thienyl)iodonium, bis(5-cyclohexyl-2-furyl)iodonium, bis(5-hydroxy-2-thienyl)iodonium, bis(5-phenoxy-2-furyl)iodonium, bis(5-mercapto-2-thienyl)iodonium, bis(5-butylthio-2-thienyl)iodonium, and bis(5-phenylthio-2-thienyl)iodonium.

Examples of the onium cation (diaryliodonium cation) corresponding to general formula (12) include, but are not limited to, diphenyliodonium, bis(p-tolyl)iodonium, bis(p-octylphenyl)iodonium, bis(p-octadecylphenyl)iodonium, bis(p-octyloxyphenyl)iodonium, bis(p-octadecyloxyphenyl)iodonium, phenyl(p-octadecyloxyphenyl)iodonium, 4-isopropyl-4′-methyldiphenyliodonium, (4-isobutylphenyl)-p-tolyliodonium, bis(1-naphthyl)iodonium, bis(4-phenylsulfanylphenyl)iodonium, phenyl(6-benzoyl-9-ethyl-9H-carbazol-3-yl)iodonium, (7-methoxy-2-oxo-2H-chromen-3-yl)-4′-isopropylphenyliodoniu m.

Next, the counter anion X⁻ in general formula (3) will be described.

Although not restricted in principle, the counter anion X⁻ in general formula (3) is preferably a non-nucleophilic anion. When the counter anion X⁻ is a non-nucleophilic anion, nucleophilic reaction is less likely to occur with the coexisting cation in the molecule or with various materials used in combination with the anion, so that the photo-acid generator of general formula (2) itself and the composition containing it can have improved stability over time. As used herein, the term “non-nucleophilic anion” refers to an anion less capable of undergoing nucleophilic reaction. Examples of such an anion include PF₆⁻, SbF₆⁻, AsF₆⁻, SbCl₆⁻, BiCl₅⁻, SnCl₆⁻, ClO₄⁻, dithiocarbamate anion, and SCN⁻.

In particular, among the anions listed above, the counter anion X⁻ in general formula (3) is preferably PF₆⁻, SbF₆⁻, or AsF₆₋, more preferably PF₆⁻ or SbF₆⁻.

In the present invention, therefore, preferred examples of the onium salt that forms the photo-acid generator (G) include onium salts composed of any of examples of the onium cation structures of general formulae (3) to (12) shown above and any anion selected from PF₆⁻, SbF₆⁻, AsF₆⁻, SbCl₆⁻, BiCl₅⁻, SnCl₆⁻, ClO₄⁻, dithiocarbamate anion, and SCN⁻.

More specifically, in the present invention, preferred examples of the photo-acid generator (G) include CYRACURE UVI-6992 and CYRACURE UVI-6974 (all manufactured by The Dow Chemical Company), ADEKA OPTOMER SP150, ADEKA OPTOMER SP152, ADEKA OPTOMER SP170, and ADEKA OPTOMER SP172 (all manufactured by ADEKA CORPORATION), IRGACURE 250 (manufactured by Ciba Specialty Chemicals Inc.), CI-5102 and CI-2855 (all manufactured by Nippon Soda Co., Ltd.), SAN-AID SI-60L, SAN-AID SI-80L, SAN-AID SI-100L, SAN-AID SI-110L, and SAN-AID SI-180L (all manufactured by SANSHIN CHEMICAL INDUSTRY CO., LTD.), CPI-100P and CPI-100A (all manufactured by SAN-APRO LTD.), and WPI-069, WPI-113, WPI-116, WPI-041, WPI-044, WPI-054, WPI-055, WPAG-281, WPAG-567, and WPAG-596 (all manufactured by Wako Pure Chemical Industries, Ltd.).

The content of the photo-acid generator (G) is preferably from 0.01 to 10 parts by weight, more preferably from 0.05 to 5 parts by weight, even more preferably from 0.1 to 3 parts by weight, based on the total weight of the active energy ray-curable resin composition.

(Epoxy Group-Containing Compound and Polymer) (H)

A compound having one or more epoxy groups per molecule or a polymer (epoxy resin) having two or more epoxy groups per molecule may be used. In this case, a compound having two or more functional groups per molecule reactive with an epoxy group may be used in combination with the epoxy group-containing compound or polymer. The functional group reactive with an epoxy group is typically carboxyl, phenolic hydroxyl, mercapto, or primary or secondary aromatic amino. In particular, the compound preferably has two or more functional groups of any of these types per molecule in view of three-dimensionally curing properties.

Examples of polymers having one or more epoxy groups per molecule include epoxy resins such as bisphenol A epoxy resins derived from bisphenol A and epichlorohydrin, bisphenol F epoxy resins derived from bisphenol F and epichlorohydrin, bisphenol S epoxy resins, phenol novolac epoxy resins, cresol novolac epoxy resins, bisphenol A novolac epoxy resins, bisphenol F novolac epoxy resins, alicyclic epoxy resins, diphenyl ether epoxy resins, hydroquinone epoxy resins, naphthalene epoxy resins, biphenyl epoxy resins, fluorene epoxy resins, polyfunctional epoxy resins such as trifunctional epoxy resins and tetrafunctional epoxy resins, glycidyl ester epoxy resins, glycidyl amine epoxy resins, hydantoin epoxy resins, isocyanurate epoxy resins, and aliphatic chain epoxy resins. These epoxy resins may be halogenated or hydrogenated. Examples of commercially available epoxy resin products include, but are not limited to, EPIKOTE 828, EPIKOTE 1001, EPIKOTE 801N, EPIKOTE 806, EPIKOTE 807, EPIKOTE 152, EPIKOTE 604, EPIKOTE 630, EPIKOTE 871, EPIKOTE YX8000, EPIKOTE YX8034, and EPIKOTE YX4000 manufactured by Japan Epoxy Resins Co., Ltd., EPICLON 830, EPICLON EXA-835LV, EPICLON HP-4032D, and EPICLON HP-820 manufactured by DIC Corporation, EP4100 series, EP4000 series, and EPU series manufactured by ADEKA CORPORATION, CELLOXIDE series (e.g., 2021, 2021P, 2083, 2085, and 3000), EPOLEAD series, and EHPE series manufactured by DAICEL CORPORATION, YD series, YDF series, YDCN series, YDB series, and phenoxy resins (polyhydroxypolyethers synthesized from bisphenols and epichlorohydrin and terminated at both ends with epoxy groups, e.g, YP series) manufactured by NIPPON STEEL & SUMIKIN CHEMICAL CO., LTD., DENACOL series manufactured by Nagase ChemteX Corporation, and Epolite series manufactured by Kyoeisha Chemical Co., Ltd. These epoxy resins may be used in combination of two or more. It should be noted that the epoxy group-containing compound and polymer (G) are not taken into account in the calculation of the glass transition temperature Tg of the adhesive layer.

(Alkoxyl Group-Containing Compound and Polymer) (H)

The compound having an alkoxyl group in the molecule may be any known compound having one or more alkoxyl group per molecule. Such a compound is typically a melamine compound, an amino-resin, and a silane coupling agent. It should be noted that the alkoxyl group-containing compound and polymer (H) are not taken into account in the calculation of the glass transition temperature Tg of the adhesive layer.

Examples of an amino group-containing silane coupling agent (I) include amino group-containing silanes such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilane, (2-aminoethyl)aminomethyltrimethoxysilane, and N,N′-bis[3-(trimethoxysilyl)propyl]ethylenediamine; and ketimine silanes such as N-(1,3-dimethylbutylidene)-3-(triethoxysilyl)-1-propaneamine.

These amino group-containing silane coupling agents (I) may be used singly or in combination of two or more. Among them, γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propaneamine are preferred in order to ensure good tackiness.

The content of the amino group-containing silane coupling agent (I) is preferably in the range of 0.01 to 20% by weight, more preferably 0.05 to 15 parts by weight, even more preferably 0.1 to 10 parts by weight, based on 100% by weight of the total amount of the composition. If the content is more than 20 parts by weight, the adhesive may have poor storage stability, and if the content is less than 0.1 parts by weight, the effect of water-resistant tackiness may fail to be sufficiently produced. It should be noted that the amino group-containing silane coupling agent (I) is not taken into account in the calculation of the glass transition temperature Tg of the adhesive layer.

The active energy ray-curable adhesive composition according to the present invention contains 25 to 80% by weight of the radically polymerizable compound (B) based on 100% by weight of the total amount of the composition. In addition, the active energy ray-curable adhesive composition preferably contains 3 to 40% by weight of the radically polymerizable compound (A), 5 to 55% by weight of the radically polymerizable compound (C), and 3 to 20% by weight of the acrylic oligomer (D) based on 100% by weight of the total amount of the composition.

When the active energy ray-curable adhesive composition according to the present invention is to be used as an electron beam-curable type, it is not particularly necessary to add a photopolymerization initiator to the composition. However, when the adhesive composition is to be used as an ultraviolet-curable type, a photopolymerization initiator is preferably used in the adhesive composition, and in particular, a photopolymerization initiator having high sensitivity to light of 380 nm or longer is preferably used in the adhesive composition. The photopolymerization initiator having high sensitivity to light of 380 nm or longer will be described below.

In the active energy ray-curable adhesive composition according to the present invention, a compound represented by formula (1):

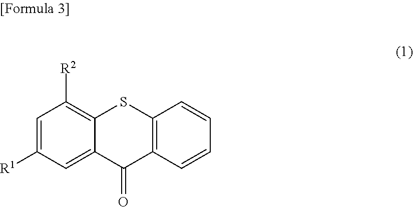

wherein R¹ and R² each represent —H, —CH₂CH₃, —IPR, or Cl, and R¹ and R² may be the same or different, is preferably used alone as a photopolymerization initiator or preferably used as a photopolymerization initiator in combination with another photopolymerization initiator having high sensitivity to light of 380 nm or longer described below. The resulting adhesion is higher when the compound of formula (1) is used than when a photopolymerization initiator having high sensitivity to light of 380 nm or longer is used alone. In particular, the compound of formula (1) is preferably diethyl thioxanthone in which R¹ and R² are each —CH₂CH₃. Based on 100% by weight of the total amount of the composition, the content of the compound of formula (1) in the composition is preferably from 0.1 to 5.0% by weight, more preferably from 0.5 to 4.0% by weight, even more preferably from 0.9 to 3.0% by weight.

If necessary, a polymerization initiation aid is preferably added to the composition. In particular, the polymerization initiation aid is preferably triethylamine, diethylamine, N-methyldiethanolamine, ethanolamine, 4-dimethylaminobenzoic acid, methyl 4-dimethylaminobenzoate, ethyl 4-dimethylaminobenzoate, or isoamyl 4-dimethylaminobenzoate. Ethyl 4-dimethylaminobenzoate is particularly preferred. When the polymerization initiation aid is used, the content of the aid is generally 0 to 5% by weight, preferably 0 to 4% by weight, most preferably 0 to 3% by weight, based on 100% by weight of the total amount of the composition.

If necessary, a known photopolymerization initiator may be used in combination. Since the transparent protective film having the ability to absorb UV does not transmit light of 380 nm or shorter, such a photopolymerization initiator should preferably have high sensitivity to light of 380 nm or longer. Examples of such an initiator include 2-methyl-1-(4-methylthiophenyl)-2-morpholinopropan-1-on, 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, and bis(H5-2,4-cyclopentadien-1-yl)-bis(2,6-difluoro-3-(1H-pyrrol-1-yl)-phenyl) titanium.

In particular, a compound represented by formula (2):

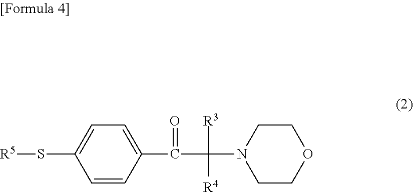

wherein R³, R⁴, and R⁵ each represent —H, —CH₃, —CH₂CH₃, —IPR, or Cl, and R³, R⁴, and R⁵ may be the same or different, is preferably used in addition to the photopolymerization initiator of formula (1). Commercially available 2-methyl-1-(4-methylthiophenyl)-2-morpholinopropan-1-on (IRGACURE 907 (trade name) manufactured by BASF) is advantageously used as the compound of formula (2). Besides this, 2-benzyl-2-dimethylamino-1-(4-morpholinophenyl)-butanone-1 (IRGACURE 369 (trade name) manufactured by BASF) and 2-(dimethylamino)-2-[(4-methylphenyl)methyl]-1-[4-(4-morpholinyl)phenyl]-1-butanone (IRGACURE 379 (trade name) manufactured by BASF) are preferred because of their high sensitivity.

The active energy ray-curable adhesive composition according to the present invention may also contain any of various additives as other optional components as long as the objects and effects of the present invention are not impaired. Examples of such additives include polymers or oligomers such as epoxy resin, polyamide, polyamide imide, polyurethane, polybutadiene, polychloroprene, polyether, polyester, styrene-butadiene block copolymers, petroleum resin, xylene resin, ketone resin, cellulose resin, fluorooligomers, silicone oligomers, and polysulfide oligomers, polymerization inhibitors such as phenothiazine and 2,6-di-tert-butyl-4-methylphenol, polymerization initiation aids, leveling agents, wettability modifiers, surfactants, plasticizers, ultraviolet absorbers, silane coupling agents, inorganic fillers, pigments, and dyes.

Among these additives, silane coupling agents can impart higher water resistance by acting on the surface of the polarizer. When a silane coupling agent is used, the content of the silane coupling agent is generally 0 to 10% by weight, preferably 0 to 5% by weight, most preferably 0 to 3% by weight, based on 100% by weight of the total amount of the composition.

The silane coupling agent to be used is preferably an active energy ray-curable compound. However, even when it is not active energy ray-curable, it can also impart a similar level of water resistance.

Examples of silane coupling agents as active energy ray-curable compounds include vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Examples of non-active-energy-ray-curable silane coupling agents include N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

Preferred are 3-methacryloxypropyltrimethoxysilane and 3-acryloxypropyltrimethoxysilane.

The active energy ray-curable adhesive composition according to the present invention can be cured to form an adhesive layer by being irradiated with active energy rays.

The active energy rays to be used may include electron beams or visible rays with wavelengths ranging from 380 nm to 450 nm. Although the long wavelength limit of the visible rays is around 780 nm, visible rays with wavelengths of more than 450 nm would not take part in the absorption by polymerization initiators and may cause a transparent protective film and a polarizer to generate heat. In the present invention, therefore, a band pass filter is preferably used to block visible rays with wavelengths longer than 450 nm.

Electron beams may be applied under any appropriate conditions where the active energy ray-curable adhesive composition can be cured. For example, electron beams are preferably applied at an acceleration voltage of 5 kV to 300 kV, more preferably 10 kV to 250 kV. If the acceleration voltage is lower than 5 kV, electron beams may fail to reach the adhesive, so that insufficient curing may occur. If the acceleration voltage is higher than 300 kV, electron beams can have too high intensity penetrating through the material and thus may damage a transparent protective film or a polarizer. The exposure dose is preferably from 5 to 100 kGy, more preferably from 10 to 75 kGy. At an exposure dose of less than 5 kGy, the adhesive may be insufficiently cured. An exposure dose of more than 100 kGy may damage a transparent protective film or a polarizer and cause yellow discoloration or a reduction in mechanical strength, which may make it impossible to obtain the desired optical properties.

Electron beam irradiation is generally performed in an inert gas. If necessary, however, electron beam irradiation may be performed in the air or under conditions where a small amount of oxygen is introduced. When oxygen is appropriately introduced, oxygen-induced inhibition can be intentionally produced on the surface of a transparent protective film, to which electron beams are first applied, so that the transparent protective film can be prevented from being damaged and electron beams can be efficiently applied only to the adhesive, although it depends on the material of the transparent protective film.

The method according to the present invention for manufacturing a polarizing film can prevent curling of the polarizing film while increasing the adhesion performance of the adhesive layer between the polarizer and the transparent protective film. To achieve this effect, the active energy rays used preferably include visible rays with a wavelength ranging from 380 nm to 450 nm, specifically, visible rays whose dose is the highest at a wavelength ranging from 380 nm to 450 nm. When the transparent protective film used has the ability to absorb ultraviolet rays (the ultraviolet non-transmitting transparent protective film), it can absorb light with wavelengths shorter than about 380 nm. This means that light with wavelengths shorter than 380 nm cannot reach the active energy ray-curable adhesive composition and thus cannot contribute to the polymerization reaction of the composition. When absorbed by the transparent protective film, the light with wavelengths shorter than 380 nm is also converted into heat, so that the transparent protective film itself can generate heat, which can cause a defect such as curling or wrinkling of the polarizing film. In the present invention, therefore, the active energy ray generator used preferably does not emit light with wavelengths shorter than 380 nm. More specifically, the ratio of the total illuminance in the wavelength range of 380 to 440 nm to the total illuminance in the wavelength range of 250 to 370 nm is preferably from 100:0 to 100:50, more preferably from 100:0 to 100:40. The source of energy rays satisfying such a relation for the total illuminance is preferably a gallium-containing metal halide lamp or an LED light source emitting light with a wavelength ranging from 380 to 440 nm. Alternatively, a low-pressure mercury lamp, a middle-pressure mercury lamp, a high-pressure mercury lamp, an ultrahigh-pressure mercury lamp, an incandescent lamp, a xenon lamp, a halogen lamp, a carbon arc lamp, a metal halide lamp, a fluorescent lamp, a tungsten lamp, a gallium lamp, an excimer laser, or sunlight may be used as the light source in combination with a band pass filter to block light with wavelengths shorter than 380 nm. For the purpose of preventing the polarizing film from curling while increasing the adhesion performance of the adhesive layer between the polarizer and the transparent protective film, it is preferable to use active energy rays obtained through a band pass filter capable of blocking light with wavelengths shorter than 400 nm or to use active energy rays with a wavelength of 405 nm obtained with an LED light source.

When the active energy ray-curable adhesive composition is visible ray-curable, the active energy ray-curable adhesive composition is preferably heated before irradiated with visible rays (heating before irradiation). In this case, the composition is preferably heated to 40° C. or higher, more preferably 50° C. or higher. The active energy ray-curable adhesive composition is also preferably heated after irradiated with visible rays (heating after irradiation). In this case, the composition is preferably heated to 40° C. or higher, more preferably 50° C. or higher.

The active energy ray-curable adhesive composition according to the present invention is particularly suitable for use in forming an adhesive layer to bond a polarizer and a transparent protective film with a 365 nm wavelength light transmittance of less than 5%. When containing the photopolymerization initiator of formula (1) shown above, the active energy ray-curable adhesive composition according to the present invention can form a cured adhesive layer by being irradiated with ultraviolet rays through a transparent protective film having the ability to absorb UV. In this case, the adhesive layer can be cured even in a polarizing film including a polarizer and transparent protective films placed on both sides of the polarizer and each having the ability to absorb UV. It will be understood, however, that the adhesive layer can be cured also in a polarizing film where the transparent protective films placed on the polarizer have no ability to absorb UV. As used herein, the term “transparent protective films having the ability to absorb UV” means transparent protective films with a 380 nm light transmittance of less than 10%.

Methods for imparting the ability to absorb UV to a transparent protective film include a method of adding an ultraviolet absorber into the transparent protective film and a method of placing, on the surface of the transparent protective film, a surface treatment layer containing an ultraviolet absorber.

Examples of the ultraviolet absorber include conventionally known oxybenzophenone compounds, benzotriazole compounds, salicylate ester compounds, benzophenone compounds, cyanoacrylate compounds, nickel complex salt compounds, and triazine compounds.

The adhesive layer made from the active energy ray-curable adhesive composition has durability higher than that of an aqueous adhesive layer. In the present invention, the adhesive layer used preferably has a Tg of 60° C. or higher. The thickness of the adhesive layer is preferably controlled to 0.01 to 7 μm. Thus, when the polarizing film according to the present invention is manufactured in such a way that the active energy ray-curable adhesive composition used is capable of forming an adhesive layer with a high Tg of 60° C. or higher and the thickness of the adhesive layer is controlled to fall within the range, the polarizing film can have satisfactory durability in a severe environment at high temperate and high humidity. In view of the durability of the polarizing film, mathematical expression (1): A−12×B>58 is preferably satisfied, wherein A is the Tg (° C.) of the adhesive layer, and B is the thickness (μm) of the adhesive layer.

As shown above, the active energy ray-curable adhesive composition is preferably so selected that the adhesive layer to be made from it will have a Tg of 60° C. or higher, more preferably 70° C. or higher, even more preferably 75° C. or higher, further more preferably 100° C. or higher, still more preferably 120° C. or higher. On the other hand, if the adhesive layer has too high a Tg, the polarizing film can have low flexibility. Thus, the Tg of the adhesive layer is preferably 300° C. or lower, more preferably 240° C. or lower, even more preferably 180° C. or lower.

As mentioned above, the adhesive layer preferably has a thickness of 0.01 to 7 μm, more preferably 0.01 to 5 μm, even more preferably 0.01 to 2 μm, most preferably 0.01 to 1 μm. If the thickness of the adhesive layer is less than 0.01 μm, the adhesive itself may fail to have a cohesive strength, and a necessary bonding strength may fail to be obtained. On the other hand, if the thickness of the adhesive layer is more than 7 μm, the polarizing film can have insufficient durability.

The present invention is also directed to a method for manufacturing a polarizing film including a polarizer, a transparent protective film provided on at least one surface of the polarizer and having a transmittance of less than 5% for light with a wavelength of 365 nm, and an adhesive layer interposed between the polarizer and the transparent protective film, the method including: an application step including applying the active energy ray-curable adhesive composition having any of the features described above to the surface of at least one of the polarizer or the transparent protective film; a lamination step including laminating the polarizer and the transparent protective film; and a bonding step including curing the active energy ray-curable adhesive composition by applying active energy rays to the composition from the polarizer side or the transparent protective film side to form an adhesive layer, so that the polarizer and the transparent protective film are bonded with the adhesive layer interposed therebetween. During the lamination step, the polarizer may have a water content of less than 15%. This water content is advantageous in that the intensity of drying of the polarizing film, which is obtained after the lamination step (lamination), can be reduced. The polarizer with such a low water content may be a thin polarizer whose water content can be easily reduced during drying by heating. Such a thin polarizer will be described below.

The polarizer or the transparent protective film may be subjected to a surface modification treatment before the active energy ray-curable adhesive composition is applied thereto. Specifically, such a treatment may be a corona treatment, a plasma treatment, a saponification treatment, an excimer treatment, or a flame treatment.

The method for applying the active energy ray-curable adhesive composition is appropriately selected depending on the viscosity of the composition or the desired thickness. Examples of application means include a reverse coater, a gravure coater (direct, reverse, or offset), a bar reverse coater, a roll coater, a die coater, a bar coater, a rod coater, etc. Any other suitable application method such as dipping may also be used.

The polarizer and the transparent protective film are laminated with the adhesive interposed therebetween, which has been applied as described above. The lamination of the polarizer and the transparent protective film may be performed using a roll laminator or other laminators.

After the polarizer and the transparent protective film are laminated, the active energy ray-curable adhesive composition is cured by the application of active energy rays (such as electron beams, ultraviolet rays, or visible rays) to form an adhesive layer. Active energy rays (such as electron beams, ultraviolet rays, or visible rays) may be applied in any suitable direction. Preferably, active energy rays are applied to the composition from the transparent protective film side. If applied from the polarizer side, active energy rays (such as electron beams, ultraviolet rays, or visible rays) may degrade the polarizer.

The method may also be for manufacturing a polarizing film including a polarizer, transparent protective films provided on both sides of the polarizer and each having a transmittance of less than 5% for light with a wavelength of 365 nm, and adhesive layers each interposed between the polarizer and the transparent protective film. In this case, the bonding step of the manufacturing method may include curing the active energy ray-curable adhesive composition by first applying active energy rays to the composition from one transparent productive film side and then applying active energy rays to the composition from the other transparent protective film side to form adhesive layers, so that the polarizer and the transparent protective films are bonded with the adhesive layers interposed therebetween.

The process of first applying active energy rays from one transparent productive film side and then applying active energy rays from the other transparent protective film side (two-stage irradiation) is superior to the process of applying active energy rays only from one transparent protective film side (single-stage irradiation) in that the former can provide a higher rate of reaction for the adhesive layer and higher adhesion between the polarizer and the transparent protective film while preventing the transparent protective film from curling.

When the polarizing film according to the present invention is manufactured using a continuous line, the line speed is preferably from 1 to 500 m/minute, more preferably from 5 to 300 m/minute, even more preferably from 10 to 100 m/minute, depending on the time required to cure the adhesive. If the line speed is too low, the productivity can be low, or damage to the transparent protective film can be too much, which can make it impossible to produce a polarizing film capable of withstanding durability tests and so on. If the line speed is too high, the adhesive can be insufficiently cured, so that the desired adhesion may fail to be obtained.

The polarizing film according to the present invention, which has the polarizer and the transparent protective film bonded together with the adhesive layer interposed therebetween and made of a curing product of the active energy ray-curable adhesive composition, may further include an adhesion-facilitating layer between the transparent protective film and the adhesive layer. For example, the adhesion-facilitating layer may be made of any of various resins having a polyester skeleton, a polyether skeleton, a polycarbonate skeleton, a polyurethane skeleton, a silicone moiety, a polyamide skeleton, a polyimide skeleton, a polyvinyl alcohol skeleton, or other polymer skeletons. These polymer resins may be used singly or in combination of two or more. Other additives may also be added to form the adhesion-facilitating layer. More specifically, a tackifier, an ultraviolet absorber, an antioxidant, or a stabilizer such as a heat-resistant stabilizer may also be used to form the adhesion-facilitating layer.

Usually, the adhesion-facilitating layer is provided in advance on the transparent protective film, and then the adhesion-facilitating layer side of the transparent protective film is bonded to the polarizer with the adhesive layer. The adhesion-facilitating layer can be formed using a known technique that includes applying an adhesion-facilitating-layer-forming material onto the transparent protective film and drying the material. The adhesion-facilitating-layer-forming material is generally prepared in the form of a solution which is diluted to a suitable concentration taking into account the coating thickness after drying, the smoothness of the application, and other factors. After dried, the adhesion-facilitating layer preferably has a thickness of 0.01 to 5 μm, more preferably 0.02 to 2 μm, even more preferably 0.05 to 1 μm. Two or more adhesion-facilitating layers may be provided. Also in this case, the total thickness of the adhesion-facilitating layers preferably falls within such ranges.

The polarizing film of the present invention includes a polarizer and a transparent protective film bonded to at least one side of the polarizer with an adhesive layer interposed between the polarizer and the transparent protective film and made of a curing product of the active energy ray-curable adhesive composition.

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous. The thickness of the polarizer is generally, but not limited to, about 80 μm or less.

For example, a polarizer including a uniaxially-stretched polyvinyl alcohol-based film dyed with iodine can be produced by a process including immersing a polyvinyl alcohol film in an aqueous iodine solution to dye the film and stretching the film to 3 to 7 times the original length. If necessary, the film may also be immersed in an aqueous solution of boric acid or potassium iodide or the like. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

A thin polarizer with a thickness of 10 μm or less may also be used. In view of thickness reduction, the thickness is preferably from 1 to 7 μm. Such a thin polarizer is less uneven in thickness, has good visibility, and is less dimensionally-variable, and thus has high durability. It is also preferred because it can form a thinner polarizing film. The thin polarizer is also advantageously used as a polarizer with a water content of less than 15% because its water content can be easily reduced during drying by heating.

Typical examples of such a thin polarizer include the thin polarizing films described in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

Among processes including the steps of stretching and dyeing a laminate, a process capable of achieving high-ratio stretching to improve polarizing performance is preferably used when the thin polarizing film is formed. Thus, the thin polarizing film is preferably obtained by a process including the step of stretching in an aqueous boric acid solution as described in WO2010/100917, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as described in Japanese Patent Application No. 2010-269002 or 2010-263692.

PCT/JP2010/001460 describes a thin highly-functional polarizing film that is formed integrally with a resin substrate, made of a PVA-based resin containing an oriented dichroic material, and has a thickness of 7 μm or less and the optical properties of a single transmittance of 42.0% or more and a degree of polarization of 99.95% or more.

This thin highly-functional polarizing film can be produced by a process including forming a PVA-based resin coating on a resin substrate with a thickness of at least 20 μm, drying the coating to form a PVA-based resin layer, immersing the resulting PVA-based resin layer in a dyeing liquid containing a dichroic material to adsorb the dichroic material to the PVA-based resin layer, and stretching the PVA-based resin layer, which contains the adsorbed dichroic material, together with the resin substrate in an aqueous boric acid solution to a total stretch ratio of 5 times or more the original length.

A laminated film including a thin highly-functional polarizing film containing an oriented dichroic material can also be produced by a method including the steps of: applying a PVA-based resin-containing aqueous solution to one side of a resin substrate with a thickness of at least 20 μm, drying the coating to form a PVA-based resin layer so that a laminated film including the resin substrate and the PVA-based resin layer formed thereon is produced; immersing the laminated film in a dyeing liquid containing a dichroic material to adsorb the dichroic material to the PVA-based resin layer in the laminated film, wherein the laminated film includes the resin substrate and the PVA-based resin layer formed on one side of the resin substrate; and stretching the laminated film, which has the PVA-based resin layer containing the adsorbed dichroic material, in an aqueous boric acid solution to a total stretch ratio of 5 times or more the original length, wherein the PVA-based resin layer containing the adsorbed dichroic material is stretched together with the resin substrate, so that a laminated film including the resin substrate and a thin highly-functional polarizing film formed on one side of the resin substrate is produced, in which the thin highly-functional polarizing film is made of the PVA-based resin layer containing the oriented dichroic material and has a thickness of 7 μm or less and the optical properties of a single transmittance of 42.0% or more and a degree of polarization of 99.95% or more.

The thin polarizing film disclosed in Japanese Patent Application No. 2010-269002 or 2010-263692 is a polarizing film in the form of a continuous web including a PVA-based resin containing an oriented dichroic material, which is made with a thickness of 10 μm or less by a two-stage stretching process including auxiliary in-air stretching of a laminate and stretching of the laminate in an aqueous boric acid solution, wherein the laminate includes an amorphous polyester-based thermoplastic resin substrate and a PVA-based resin layer formed thereon. This thin polarizing film is preferably made to have optical properties satisfying the following conditions: P>−(100.929T−42.4−1)×100 (provided that T<42.3) and P≧99.9 (provided that T≧42.3), wherein T represents the single transmittance, and P represents the degree of polarization.

Specifically, the thin polarizing film can be produced by a thin polarizing film-manufacturing method including the steps of: performing elevated temperature in-air stretching of a PVA-based resin layer formed on an amorphous polyester-based thermoplastic resin substrate in the form of a continuous web, so that a stretched intermediate product including an oriented PVA-based resin layer is produced; adsorbing a dichroic material (which is preferably iodine or a mixture of iodine and an organic dye) to the stretched intermediate product to produce a dyed intermediate product including the PVA-based resin layer and the dichroic material oriented therein; and performing stretching of the dyed intermediate product in an aqueous boric acid solution so that a polarizing film with a thickness of 10 μm or less is produced, which includes the PVA-based resin layer and the dichroic material oriented therein.

In this manufacturing method, the elevated temperature in-air stretching and the stretching in an aqueous boric acid solution are preferably performed in such a manner that the PVA-based resin layer formed on the amorphous polyester-based thermoplastic resin substrate is stretched to a total stretch ratio of 5 times or more. The temperature of the aqueous boric acid solution for the stretching therein may be 60° C. or higher. Before stretched in the aqueous boric acid solution, the dyed intermediate product is preferably subjected to an insolubilization treatment, in which the dyed intermediate product is preferably immersed in an aqueous boric acid solution at a temperature of 40° C. or less. The amorphous polyester-based thermoplastic resin substrate may be made of amorphous polyethylene terephthalate including co-polyethylene terephthalate in which isophthalic acid, cyclohexanedimethanol, or any other monomer is copolymerized. The amorphous polyester-based thermoplastic resin substrate is preferably made of a transparent resin. The thickness of the substrate may be at least seven times the thickness of the PVA-based resin layer to be formed. The elevated temperature in-air stretching is preferably performed at a stretch ratio of 3.5 times or less. The temperature of the elevated temperature in-air stretching is preferably equal to or higher than the glass transition temperature of the PVA-based resin. Specifically, it is preferably in the range of 95° C. to 150° C. When the elevated temperature in-air stretching is end-free uniaxial stretching, the PVA-based resin layer formed on the amorphous polyester-based thermoplastic resin substrate is preferably stretched to a total stretch ratio of 5 to 7.5 times. When the elevated temperature in-air stretching is fixed-end uniaxial stretching, the PVA-based resin layer formed on the amorphous polyester-based thermoplastic resin substrate is preferably stretched to a total stretch ratio of 5 to 8.5 times.

More specifically, the thin polarizing film can be produced by the method described below.

A substrate is prepared in the form of a continuous web, which is made of co-polyethylene terephthalate-isophthalate (amorphous PET) containing 6 mol % of copolymerized isophthalic acid. The amorphous PET has a glass transition temperature of 75° C. A laminate of a polyvinyl alcohol (PVA) layer and the amorphous PET substrate in the form of a continuous web is prepared as described below. For reference, the glass transition temperature of PVA is 80° C.

A 200-μm-thick amorphous PET substrate is provided, and an aqueous 4-5% PVA solution is prepared by dissolving a powder of PVA with a polymerization degree of 1,000 or more and a saponification degree of 99% or more in water. Subsequently, the aqueous PVA solution is applied to the 200-μm-thick amorphous PET substrate and dried at a temperature of 50 to 60° C. so that a laminate composed of the amorphous PET substrate and a 7-μm-thick PVA layer formed thereon is obtained.

The laminate having the 7-μm-thick PVA layer is subjected to a two-stage stretching process including auxiliary in-air stretching and stretching in an aqueous boric acid solution as described below, so that a thin highly-functional polarizing film with a thickness of 3 μm is obtained. At the first stage, the laminate having the 7-μm-thick PVA layer is subjected to an auxiliary in-air stretching step so that the layer is stretched together with the amorphous PET substrate to form a stretched laminate having a 5-μm-thick PVA layer. Specifically, the stretched laminate is formed by a process including feeding the laminate having the 7-μm-thick PVA layer to a stretching apparatus placed in an oven with the stretching temperature environment set at 130° C. and subjecting the laminate to end-free uniaxial stretching to a stretch ratio of 1.8 times. In the stretched laminate, the PVA layer is modified, by the stretching, into a 5-μm-thick PVA layer containing oriented PVA molecules.

Subsequently, a dyeing step is performed to produce a dyed laminate having a 5-μm-thick PVA layer containing oriented PVA molecules and adsorbed iodine. Specifically, the dyed laminate is produced by immersing the stretched laminate for a certain period of time in a dyeing liquid containing iodine and potassium iodide and having a temperature of 30° C. so that iodine can be adsorbed to the PVA layer of the stretched laminate and so that the PVA layer for finally forming a highly-functional polarizing film can have a single transmittance of 40 to 44%. In this step, the dyeing liquid contains water as a solvent and has an iodine concentration in the range of 0.12 to 0.30% by weight and a potassium iodide concentration in the range of 0.7 to 2.1% by weight. The concentration ratio of iodine to potassium iodide is 1:7. It should be noted that potassium iodide is necessary to make iodine soluble in water. More specifically, the stretched laminate is immersed for 60 seconds in a dyeing liquid containing 0.30% by weight of iodine and 2.1% by weight of potassium iodide, so that a dyed laminate is produced, in which the 5-μm-thick PVA layer contains oriented PVA molecules and adsorbed iodine.

At the second stage, the dyed laminate is further subjected to a stretching step in an aqueous boric acid solution so that the layer is further stretched together with the amorphous PET substrate to form an optical film laminate having a 3-μm-thick PVA layer, which forms a highly-functional polarizing film. Specifically, the optical film laminate is formed by a process including feeding the dyed laminate to a stretching apparatus placed in a treatment system where an aqueous boric acid solution containing boric acid and potassium iodide is set in the temperature range of 60 to 85° C., and subjecting the laminate to end-free uniaxial stretching to a stretch ratio of 3.3 times. More specifically, the aqueous boric acid solution has a temperature of 65° C. In the solution, the boric acid content and the potassium iodide content are 4 parts by weight and 5 parts by weight, respectively, based on 100 parts by weight of water. In this step, the dyed laminate having a controlled amount of adsorbed iodine is first immersed in the aqueous boric acid solution for 5 to 10 seconds. Subsequently, the dyed laminate is directly fed between a plurality of pairs of rolls different in peripheral speed, which form the stretching apparatus placed in the treatment system, and subjected to end-free uniaxial stretching for 30 to 90 seconds to a stretch ratio of 3.3 times. This stretching treatment converts the PVA layer of the dyed laminate to a 3-μm-thick PVA layer in which the adsorbed iodine forms a polyiodide ion complex highly oriented in a single direction. This PVA layer forms a highly-functional polarizing film in the optical film laminate.

A cleaning step, although not essential for the manufacture of the optical film laminate, is preferably performed, in which the optical film laminate is taken out of the aqueous boric acid solution, and boric acid deposited on the surface of the 3-μm-thick PVA layer formed on the amorphous PET substrate is washed off with an aqueous potassium iodide solution. Subsequently, the cleaned optical film laminate is dried in a drying step using warm air at 60° C. It should be noted that the cleaning step is to prevent appearance defects such as boric acid precipitation.

A lamination and/or transfer step, although not essential for the manufacture of the optical film laminate, may also be performed, in which an 80-μm-thick triacetylcellulose film is bonded to the surface of the 3-μm-thick PVA layer on the amorphous PET substrate, while an adhesive is applied to the surface, and then the amorphous PET substrate is peeled off, so that the 3-μm-thick PVA layer is transferred onto the 80-μm-thick triacetylcellulose film.

[Other Steps]

The thin polarizing film-manufacturing method may include other steps in addition to the above steps. For example, such other steps may include an insolubilization step, a crosslinking step, a drying step (moisture control), etc. Other steps may be performed at any appropriate timing.

The insolubilization step is typically achieved by immersing the PVA-based resin layer in an aqueous boric acid solution. The insolubilization treatment can impart water resistance to the PVA-based resin layer. The concentration of boric acid in the aqueous boric acid solution is preferably from 1 to 4 parts by weight based on 100 parts by weight of water. The insolubilization bath (aqueous boric acid solution) preferably has a temperature of 20° C. to 50° C. Preferably, the insolubilization step is performed after the preparation of the laminate and before the dyeing step or the step of stretching in water.

The crosslinking step is typically achieved by immersing the PVA-based resin layer in an aqueous boric acid solution. The crosslinking treatment can impart water resistance to the PVA-based resin layer. The concentration of boric acid in the aqueous boric acid solution is preferably from 1 to 4 parts by weight based on 100 parts by weight of water. When the crosslinking step is performed after the dyeing step, an iodide is preferably added to the solution. The addition of an iodide can suppress the elution of adsorbed iodine from the PVA-based resin layer. The amount of the addition of an iodide is preferably from 1 to 5 parts by weight based on 100 parts by weight of water. Examples of the iodide include those listed above. The temperature of the crosslinking bath (aqueous boric acid solution) is preferably from 20° C. to 50° C. Preferably, the crosslinking step is performed before the second stretching step in the aqueous boric acid solution. In a preferred embodiment, the dyeing step, the crosslinking step, and the second stretching step in the aqueous boric acid solution are performed in this order.

The material used to form the transparent protective film or films provided on one or both sides of the polarizer preferably has a high level of transparency, mechanical strength, thermal stability, water blocking properties, isotropy, etc. In particular, the material used to form the transparent protective film or films preferably has a water-vapor permeability of 150 g/m²/24 hours or less, more preferably 140 g/m²/24 hours or less, even more preferably 120 g/m²/24 hours or less. The water-vapor permeability can be determined by the method described in Examples.

The thickness of the transparent protective film may be determined as appropriate. The transparent protective film generally has a thickness of about 1 to about 500 μm, preferably 1 to 300 μm, more preferably 5 to 200 μm, in view of strength, workability such as handleability, thin layer formability, or the like. The thickness of the transparent protective film is even more preferably from 20 to 200 μm, further more preferably from 30 to 80 μm.

Examples of materials that may be used to form the transparent protective film with a satisfactorily low level of water-vapor permeability as mentioned above include polyester resin such as polyethylene terephthalate or polyethylene naphthalate, polycarbonate resin, arylate resin, amide resin such as nylon or aromatic polyamide, polyolefin polymers such as polyethylene, polypropylene, and ethylene-propylene copolymers, cyclic olefin-based resin having a cyclo-structure or a norbornene structure, (meth)acrylic resin, or any blend thereof. Among these resins, polycarbonate resin, cyclic polyolefin resin, or (meth)acrylic resin is preferred, and cyclic polyolefin resin or (meth)acrylic resin is particularly preferred.

For example, the cyclic polyolefin resin is preferably a norbornene resin. Cyclic olefin resin is a generic name for resins produced by polymerization of cyclic olefin used as a polymerizable unit, and examples thereof include the resins described in JP-A-01-240517, JP-A-03-14882, and JP-A-03-122137. Specific examples thereof include ring-opened (co)polymers of cyclic olefins, addition polymers of cyclic olefins, copolymers (typically random copolymers) of cyclic olefin and a-olefin such as ethylene or propylene, graft polymers produced by modification thereof with unsaturated carboxylic acids or derivatives thereof, and hydrides thereof. Examples of the cyclic olefin include norbornene monomers.

Cyclic polyolefin resins have various commercially available sources. Examples thereof include ZEONEX (trade name) and ZEONOR (trade name) series manufactured by ZEON CORPORATION, ARTON (trade name) series manufactured by JSR Corporation, TOPAS (trade name) series manufactured by Ticona, and APEL (trade name) series manufactured by Mitsui Chemicals, Inc.

The (meth)acrylic resin preferably has a glass transition temperature (Tg) of 115° C. or higher, more preferably 120° C. or higher, even more preferably 125° C. or higher, still more preferably 130° C. or higher. If the Tg is 115° C. or higher, the resulting polarizing film can have high durability. The upper limit to the Tg of the (meth)acrylic resin is preferably, but not limited to, 170° C. or lower, in view of formability or the like. The (meth)acrylic resin can form a film with an in-plane retardation (Re) of almost zero and a thickness direction retardation (Rth) of almost zero.

Any suitable (meth)acrylic resin may be used as long as the effects of the present invention are not impaired. Examples of such a (meth)acrylic resin include poly(meth)acrylate such as polymethyl methacrylate, methyl methacrylate-(meth)acrylic acid copolymers, methyl methacrylate-(meth)acrylic ester copolymers, methyl methacrylate-acrylic ester-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C1 to C6 alkyl (meth)acrylate) such as poly(methyl (meth)acrylate) is preferred. A methyl methacrylate-based resin composed mainly of a methyl methacrylate unit (50 to 100% by weight, preferably 70 to 100% by weight) is more preferred.

Examples of the (meth)acrylic resin include ACRYPET VH and ACRYPET VRL20A each manufactured by MITSUBISHI RAYON CO., LTD., and the (meth)acrylic resins described in JP-A-2004-70296 including (meth)acrylic resins having a ring structure in their molecule, and high-Tg (meth)acrylic resins obtained by intramolecular crosslinking or intramolecular cyclization reaction.

Lactone ring structure-containing (meth)acrylic resins may also be used. This is because they have high heat resistance and high transparency and also have high mechanical strength after biaxially stretched.

Examples of the lactone ring structure-containing (meth)acrylic reins include the lactone ring structure-containing (meth)acrylic reins described in JP-A-2000-230016, JP-A-2001-151814, JP-A-2002-120326, JP-A-2002-254544, and JP-A-2005-146084.

The low-water-vapor-permeability transparent protective films provided on both front and back sides of the polarizer may be made of the same polymer material or different polymer materials.

A retardation plate having an in-plane retardation of 40 nm or more and/or a thickness direction retardation of 80 nm or more may be used as the transparent protective film. The in-plane retardation is generally controlled to fall within the range of 40 to 200 nm, and the thickness direction retardation is generally controlled to fall within the range of 80 to 300 nm. The use of a retardation plate as the transparent protective film makes it possible to reduce the thickness because the retardation plate also functions as the transparent protective film.

Examples of the retardation plate include a birefringent film produced by uniaxially or biaxially stretching a polymer material, an oriented liquid crystal polymer film, and an oriented liquid crystal polymer layer supported on a film. While the thickness of the retardation plate is also not restricted, it is generally from about 20 to about 150 μm.

Alternatively, a film with a retardation may be bonded to a separate transparent protective film with no retardation, so that the retardation function can be imparted to the transparent protective film.

The surface of the transparent protective film, opposite to its surface where the polarizer is to be bonded, may be provided with a functional layer such as a hard coat layer, an anti-reflection layer, an anti-sticking layer, a diffusion layer, or an antiglare layer. The functional layer such as a hard coat layer, an anti-reflection layer, an anti-sticking layer, a diffusion layer, or an antiglare layer may be provided as part of the transparent protective film itself or as a layer independent of the transparent protective film.

For practical use, the polarizing film according to the present invention may be laminated with any other optical layer or layers to form an optical film. As a non-limiting example, such an optical layer or layers may be one or more optical layers that have ever been used to form liquid crystal display devices, etc., such as a reflector, a transflector, a retardation plate (including a wavelength plate such as a half or quarter wavelength plate), or a viewing angle compensation film. Particularly preferred is a reflective or transflective polarizing film including a laminate of the polarizing film according to the present invention and a reflector or a transflector, an elliptically or circularly polarizing film including a laminate of the polarizing film according to the present invention and a retardation plate, a wide viewing angle polarizing film including a laminate of the polarizing film according to the present invention and a viewing angle compensation film, or a polarizing film including a laminate of the polarizing film according to the present invention and a brightness enhancement film.

The optical film including a laminate of the polarizing film and the optical layer may be formed by a method of stacking them one by one in the process of manufacturing a liquid crystal display device or the like. However, an optical film formed in advance by lamination is advantageous in that it can facilitate the process of manufacturing a liquid crystal display device or the like, because it has stable quality and good assembling workability. In the lamination, any appropriate bonding means such as a pressure-sensitive adhesive layer may be used. When the polarizing film and any other optical film are bonded together, their optical axes may be each aligned at an appropriate angle, depending on the desired retardation properties or other desired properties.

A pressure-sensitive adhesive layer for bonding to any other member such as a liquid crystal cell may also be provided on the polarizing film or the optical film including a laminate having at least one layer of the polarizing film. As a non-limiting example, the pressure-sensitive adhesive for use in forming the pressure-sensitive adhesive layer may be appropriately selected from pressure-sensitive adhesives containing, as a base polymer, an acryl-based polymer, a silicone-based polymer, polyester, polyurethane, polyamide, polyether, a fluoropolymer, or a rubber polymer. In particular, a pressure-sensitive adhesive having a high level of optical transparency, weather resistance, and heat resistance and exhibiting an appropriate degree of wettability, cohesiveness, and adhesion is preferably used, such as an acrylic pressure-sensitive adhesive.

The pressure-sensitive adhesive layer may also be formed as a laminate of layers different in composition, type or other features on one or both sides of the polarizing film or the optical film. When pressure-sensitive adhesive layers are provided on both front and back sides of the polarizing plate or the optical film, they may be different in composition, type, thickness, or other features. The thickness of the pressure-sensitive adhesive layer may be determined as appropriate depending on the intended use, adhering strength, or other factors, and is generally from 1 to 500 μm, preferably from 1 to 200 μm, more preferably from 1 to 100 μm.

The exposed surface of the pressure-sensitive adhesive layer may be temporarily covered with a separator for anti-pollution or other purposes until it is actually used. This can prevent contact with the pressure-sensitive adhesive layer during usual handling. According to conventional techniques except the above thickness conditions, an appropriate separator may be used, such as a plastic film, a rubber sheet, a paper sheet, a cloth, a nonwoven fabric, a net, a foam sheet, a metal foil, any laminate thereof, or any other appropriate thin material, which is optionally coated with any appropriate release agent such as a silicone, long-chain alkyl, or fluoride release agent, or molybdenum sulfide.

The polarizing film or optical film according to the present invention is preferably used to form various devices such as liquid crystal display devices. Liquid crystal display devices may be formed according to conventional techniques. Specifically, a liquid crystal display device may be typically formed by appropriately assembling a liquid crystal cell, polarizing films or optical films, and an optional component such as a lighting system, and incorporating a driving circuit according to any conventional techniques, except that the polarizing films or optical films used are according to the present invention. The liquid crystal cell to be used may also be of any type such as TN type, STN type, or n type.

Any desired liquid crystal display device may be formed, such as a liquid crystal display device including a liquid crystal cell and the polarizing or optical film or films placed on one or both sides of the liquid crystal cell or a liquid crystal display device further including a backlight or a reflector in a lighting system. In such a case, the polarizing or optical film or films according to the present invention may be placed on one or both sides of the liquid crystal cell. When the polarizing or optical films are provided on both sides, they may be the same or different. The process of forming a liquid crystal display device may also include placing an appropriate component such as a diffusion plate, an antiglare layer, an anti-reflection film, a protective plate, a prism array, a lens array sheet, a light diffusion plate, or a backlight in one or more layers at an appropriate position or positions.

### EXAMPLES

Hereinafter, examples of the present invention will be described, which, however, should not be construed as limiting the embodiments of the present invention.

<Glass Transition Temperature (Tg)>

The Tg was measured with a dynamic viscoelastometer RSA-III manufactured by TA Instruments under the following conditions: sample size, 10 mm wide, 30 mm long; clamp distance, 20 mm; measurement mode, tensile mode; frequency, 1 Hz; rate of temperature rise, 5° C./minute. The dynamic viscoelasticity was measured, and the tan 5 peak temperature was used as the Tg.

<Water-Vapor Permeability of Transparent Protective Film>

The water-vapor permeability was measured using the water-vapor permeability test (cup method) according to JIS Z 0208. A cut piece sample with a diameter of 60 mm was placed in a moisture-permeable cup to which about 15 g of calcium chloride had been added. The cup was placed and stored in a thermostatic chamber at a temperature of 40° C. and a humidity of 90% R.H. The weight of the calcium chloride was measured before and after the storage for 24 hours, and the increase in the weight of the calcium chloride was determined and used to calculate the water-vapor permeability (g/m²/24 h).

<Transparent Protective Film>

A 40-μm-thick, lactone ring structure-containing, (meth)acrylic resin film (22.2 in SP value, 96 g/m²/24 h in water-vapor permeability) was corona-treated and then used as a transparent protective film.

<Active Energy Rays>

The source of active energy rays used was an ultraviolet irradiator (gallium-containing metal halide lamp) Light Hammer 10 manufactured by Fusion UV Systems Inc. (valve, V valve; peak illuminance, 1,600 mW/cm²; total dose, 1,000 mJ/cm²; wavelength, 380-440 nm). The illuminance of the ultraviolet rays was measured with Sola-Check System manufactured by Solatell Ltd.

(Preparation of Active Energy Ray-Curable Adhesive Compositions)

### Examples 1 to 16 and Comparative Examples 1 to 10

According to the formulation shown in Tables 2 and 3, each set of components were mixed and stirred at 50° C. for 1 hour to form each of active energy ray-curable adhesive compositions according to Examples 1 to 16 and Comparative Examples 1 to 10. In the tables, each value indicates the content in units of % by weight based on 100% by weight of the total amount of the composition. The compatibility of components in each of the adhesive compositions was evaluated under the conditions shown below. The components used are as shown below.

### Example 15A and 16A

Polarizing films were produced using the same active energy ray-curable adhesive compositions as those in Examples 15 and 16, respectively, and then evaluated as in Examples 15 and 16, except that one surface of the polarizer (the surface to be bonded to the transparent protective film) was subjected to a corona treatment before the application step. The following components were used.

(1) Radically Polymerizable Compound (A)

Hydroxyethylacrylamide (HEAA), 29.6 in SP value, capable of forming a homopolymer with a Tg of 123° C., manufactured by KOHJIN Film & Chemicals Co., Ltd.

(2) Radically Polymerizable Compound (B)

Aronix M-220 (M-220) (tripropylene glycol diacrylate), 19.0 in SP value, capable of forming a homopolymer with a Tg of 69° C., manufactured by Toagosei Co., Ltd.

(3) Radically Polymerizable Compound (C)

Acryloylmorpholine (ACMO), 22.9 in SP value, capable of forming a homopolymer with a Tg of 150° C., manufactured by KOHJIN Film & Chemicals Co., Ltd.

(4) Acrylic Oligomer (D) Formed by Polymerization of (meth)acrylic Monomer

ARUFON UP-1190 (UP-1190) manufactured by Toagosei Co., Ltd.

(5) Radically Polymerizable Compound (E) Having an Active Methylene Group

2-acetoacetoxyethyl methacrylate (AAEM), 20.23 (kJ/m³)^{1/2} in SP value, capable of forming a homopolymer with a Tg of 9° C., manufactured by The Nippon Synthetic Chemical Industry Co., Ltd.

(6) Radical Polymerization Initiator (F) Having a Hydrogen-Withdrawing Function

KAYACURE DETX-S (DETX-S) (diethyl thioxanthone) manufactured by Nippon Kayaku Co., Ltd.

(7) Photopolymerization Initiator (Compound of Formula (2))

IRGACURE 907 (IRG907) (2-methyl-1-(4-methylthiophenyl)-2-morpholinopropan-1-one), manufactured by BASF

(Preparation of Thin Polarizing Coating X and Preparation of Polarizing Film Therewith)

A thin polarizing coating X was prepared as follows. First, a laminate including an amorphous PET substrate and a 24-μm-thick PVA layer formed thereon was subjected to auxiliary in-air stretching at a stretching temperature of 130° C. to form a stretched laminate. Subsequently, the stretched laminate was subjected to dyeing to form a dyed laminate, and the dyed laminate was subjected to stretching in an aqueous boric acid solution at a stretching temperature of 65° C. to a total stretch ratio of 5.94 times, so that an optical film laminate was obtained which had a 10-μm-thick PVA layer stretched together with the amorphous PET substrate. Such two-stage stretching successfully formed an optical film laminate having a 10-μm-thick PVA layer formed on the amorphous PET substrate, in which the PVA layer contained highly oriented PVA molecules and formed a highly-functional polarizing coating Y in which iodine adsorbed by the dyeing formed a polyiodide ion complex oriented highly in a single direction. The active energy ray-curable adhesive composition according to each of Examples 1 to 16 and Comparative Examples 1 to 10 was then applied with a thickness of 0.5 μm to the surface of the thin polarizing coating X (5.0% in water content) of the optical film laminate using an MCD coater (manufactured by FUJI KIKAI KOGYO Co., Ltd; cell shape, honeycomb; the number of gravure roll lines, 1,000/inch; rotational speed, 140% relative to line speed). The adhesive-coated surface was then laminated to the transparent protective film. Using an IR heater, the laminate was heated at 50° C. from the transparent protective film side (both sides). The ultraviolet rays were applied to both sides to cure the active energy ray-curable composition according to each of Examples 1 to 16 and Comparative Examples 1 to 10. The product was then subjected to hot air drying at 70° C. for 3 minutes. Subsequently, the amorphous PET substrate was peeled off, so that a polarizing film having the thin polarizing coating X was obtained. The lamination was performed at a line speed of 25 m/minute. Each resulting polarizing film was evaluated for adhering strength, water resistance (hot water immersion test), and durability (heat shock test) under the conditions described below.

<Adhering Strength>

The polarizing film was cut into a piece with a length of 200 mm parallel to the stretched direction of the polarizer and with a width of 20 mm perpendicular thereto. In the cut piece, an incision was made between the transparent protective film (acrylic resin film, 22.2 in SP value) and the polarizer (32.8 in SP value) with a cutter knife. The cut piece of the polarizing film was bonded to a glass plate. The transparent protective film was peeled off from the polarizer at an angle of 90° and a peel rate of 500 mm/minute when the peel strength was measured using a Tensilon tester. The infrared absorption spectrum of the surface exposed by the peeling-off was also measured by ATR method, and the interface exposed by the peeling-off was evaluated based on the criteria below.

A: Cohesive failure of the protective film

B: Interfacial peeling between the protective film and the adhesive layer

C: Interfacial peeling between the adhesive layer and the polarizer

D: Cohesive failure of the polarizer

As for the above criteria, A and D mean that the adhering strength is excellent because it is higher than the cohesive strength of the film. On the other hand, B and C mean that the adhering strength at the interface between the protective film and the adhesive layer (or between the adhesive layer and the polarizer) is insufficient (or the adhering strength is poor). Taking these into account, the adhering strength evaluated as A or D is rated as ◯ (good), the adhering strength evaluated as A/B (“cohesive failure of the protective film” and “interfacial peeling between the protective film and the adhesive layer” occur simultaneously) or the adhering strength evaluated as A/C (“cohesive failure of the protective film” and “interfacial peeling between the adhesive layer and the polarizer” occur simultaneously) is rated as Δ (fair), and the adhering strength evaluated as B or C is rated as x (poor).

<Water Resistance (Hot Water Immersion Test)>

The polarizing film was cut into a rectangular piece with a length of 50 mm in the stretched direction of the polarizer and with a width of 25 mm in a direction perpendicular thereto. The cut piece of the polarizing film was immersed in hot water at 60° C. for 6 hours. Immediately after the immersion was completed, whether and how peeling occurred between the polarizer and the transparent protective film was visually observed and evaluated based on the criterial below.

◯: No peeling is observed.

Δ: Peeling occurs from the edge, but no peeling is observed in the central part.

x: Peeling occurs over the whole area.

<Durability (Heat Shock Test)>

A pressure-sensitive adhesive layer was formed on the surface of the polarizing coating of the polarizing film. The product was then cut into a rectangular piece with a width of 200 mm in the stretched direction of the polarizer and with a length of 400 mm in a direction perpendicular thereto. The cut piece of the polarizing film was laminated to a glass plate. The laminate was then subjected to a heat cycle test between −40° C. and 85° C. After 50 cycles, the polarizing film was visually observed and evaluated based on the criteria below.

◯: No cracking is observed.

Δ: Non-through cracking occurs in the stretched direction of the polarizer (a crack length of less than 200 mm)

x: Through cracking occurs in the stretched direction of the polarizer (a crack length of 200 mm)

<Compatibility>

Two glass sheets were placed parallel on both sides of 1 mm spacers, and the active energy ray-curable resin composition was inserted between the two glass sheets to form a laminate. The active energy rays were applied at a total dose of 5,000 mJ/cm² to each side of the laminate, so that a curing product of the active energy ray-curable resin composition was obtained. The curing product of the active energy ray-curable resin composition was visually observed. When a certain cloudiness was observed, the compatibility was evaluated as poor (x). When no cloudiness was observed, the compatibility was evaluated as good (◯).

TABLE 2

| | Homopolymer | SP | Example | Example | Example | Example | Example | Example | Example | Example | Example |
|---|---|---|---|---|---|---|---|---|---|---|---|
| | Tg | value | 1 | 2 | 3 | 4 | 5 | 6 | 7 | 8 | 9 |
| (A) HEAA | 123° C. | 29.6 | 16.5 | 12.4 | 10.0 | 29.9 | 29.9 | 17.6 | 7.7 | 10.0 | 8.3 |
| (B) ARONIX | 69° C. | 19 | 49.6 | 62.2 | 69.7 | 49.8 | 29.9 | 58.7 | 76.7 | 49.8 | 58.1 |
| M-220 | | | | | | | | | | | |
| (C) ACMO | 150° C. | 22.9 | 16.5 | 12.4 | 10.0 | 10.0 | 29.9 | 17.6 | 7.7 | 29.9 | 24.9 |
| (D) UP-1190 | | | 16.5 | 12.4 | 10.0 | 10.0 | 10.0 | 5.9 | 7.7 | 10.0 | 8.3 |
| IRGACURE | | | 0.5 | 0.4 | 0.3 | 0.3 | 0.3 | 0.2 | 0.2 | 0.3 | 0.2 |
| 907 | | | | | | | | | | | |
| KAYACURE | | | 0.2 | 0.2 | 0.1 | 0.1 | 0.1 | 0.1 | 0.1 | 0.1 | 0.1 |
| DETX-S | | | | | | | | | | | |

| | | | | | | | | | |
|---|---|---|---|---|---|---|---|---|---|
| Corona treatment for polarizer | Absent | Absent | Absent | Absent | Absent | Absent | Absent | Absent | Absent |
| Tg of cured adhesive | 71 | 70 | 69 | 79 | 93 | 83 | 69 | 83 | 81 |
| Adhering strength | ∘ | ∘ | ∘ | ∘ | ∘ | ∘ | Δ | Δ | Δ |
| Hot water immersion test | ∘ | ∘ | ∘ | ∘ | Δ | ∘ | ∘ | ∘ | ∘ |
| Heat shock test | ∘ | ∘ | ∘ | ∘ | ∘ | ∘ | ∘ | ∘ | ∘ |
| Compatibility | ∘ | ∘ | ∘ | ∘ | ∘ | ∘ | ∘ | ∘ | ∘ |

| | Homopolymer | SP | Example | Example | Example | Example | Example | Example | Example | Example | Example |
|---|---|---|---|---|---|---|---|---|---|---|---|
| | Tg | value | 10 | 11 | 12 | 13 | 14 | 15 | 16 | 15A | 16A |
| (A) HEAA | 123° C. | 29.6 | 6.6 | 7.1 | 5.9 | 6.2 | 5.3 | 5.3 | 4.5 | 5.3 | 4.5 |
| (B) ARONIX | 69° C. | 19 | 66.5 | 49.8 | 58.7 | 43.6 | 52.5 | 36.8 | 45.4 | 36.8 | 45.4 |
| M-220 | | | | | | | | | | | |
| (C) ACMO | 150° C. | 22.9 | 19.9 | 35.6 | 29.3 | 43.6 | 36.8 | 52.5 | 45.4 | 52.5 | 45.4 |
| (D) UP-1190 | | | 6.6 | 7.1 | 5.9 | 6.2 | 5.3 | 5.3 | 4.5 | 5.3 | 4.5 |
| IRGACURE | | | 0.2 | 0.2 | 0.2 | 0.2 | 0.2 | 0.2 | 0.1 | 0.2 | 0.1 |
| 907 | | | | | | | | | | | |
| KAYACURE | | | 0.1 | 0.1 | 0.1 | 0.1 | 0.1 | 0.1 | 0.1 | 0.1 | 0.1 |
| DETX-S | | | | | | | | | | | |

| | | | | | | | | | |
|---|---|---|---|---|---|---|---|---|---|
| Corona treatment for polarizer | Absent | Absent | Absent | Absent | Absent | Absent | Absent | Present | Present |
| Tg of cured adhesive | 79 | 90 | 85 | 96 | 91 | 103 | 98 | 103 | 98 |
| Adhering strength | Δ | Δ | Δ | Δ | Δ | Δ | Δ | ∘ | ∘ |
| Hot water immersion test | ∘ | ∘ | ∘ | ∘ | ∘ | Δ | Δ | ∘ | ∘ |
| Heat shock test | ∘ | ∘ | ∘ | ∘ | ∘ | ∘ | ∘ | ∘ | ∘ |
| Compatibility | ∘ | ∘ | ∘ | ∘ | ∘ | ∘ | ∘ | ∘ | ∘ |

TABLE 3

| | Homopolymer | | Comparative | Comparative | Comparative | Comparative | Comparative |
|---|---|---|---|---|---|---|---|
| | Tg | SP value | Example 1 | Example 2 | Example 3 | Example 4 | Example 5 |
| (A) HEAA | 123° C. | 29.6 | 16.5 | 37.3 | 29.9 | 35.6 | 31.2 |
| (B) ARONIX | 69° C. | 19 | 16.5 | 12.4 | 10.0 | 7.1 | 6.2 |
| M-220 | | | | | | | |
| (C) ACMO | 150° C. | 22.9 | 49.6 | 37.3 | 49.8 | 49.8 | 43.6 |
| (D) UP-1190 | | | 16.5 | 12.4 | 10.0 | 7.1 | 18.7 |
| IRGACURE 907 | | | 0.5 | 0.4 | 0.3 | 0.2 | 0.2 |
| KAYACURE | | | 0.2 | 0.2 | 0.1 | 0.1 | 0.1 |
| DETX-S | | | | | | | |
| Tg of cured adhesive | | | 94 | 101 | 109 | 117 | 92 |
| Adhering strength | | | x | x | x | x | x |
| Hot water immersion test | | | Δ | Δ | Δ | x | x |
| Heat shock test | | | ∘ | ∘ | ∘ | ∘ | ∘ |
| Compatibility | | | x | x | x | x | x |
| | Homopolymer | | Comparative | Comparative | Comparative | Comparative | Comparative |
| | Tg | SP value | Example 6 | Example 7 | Example 8 | Example 9 | Example 10 |
| (A) HEAA | 123° C. | 29.6 | 26.3 | 38.8 | 36.8 | 33.3 | 38.4 |
| (B) ARONIX | 69° C. | 19 | 5.3 | 5.5 | 5.3 | 4.8 | 3.8 |
| M-220 | | | | | | | |
| (C) ACMO | 150° C. | 22.9 | 52.5 | 38.8 | 52.5 | 47.5 | 38.4 |
| (D) UP-1190 | | | 15.8 | 16.6 | 5.3 | 14.3 | 19.2 |
| IRGACURE 907 | | | 0.2 | 0.2 | 0.2 | 0.1 | 0.1 |
| KAYACURE | | | 0.1 | 0.1 | 0.1 | 0.1 | 0.1 |
| DETX-S | | | | | | | |

| | | | | | |
|---|---|---|---|---|---|
| Tg of cured adhesive | 99 | 95 | 121 | 102 | 91 |
| Adhering strength | x | x | x | x | x |
| Hot water immersion test | x | x | x | x | x |
| Heat shock test | ∘ | ∘ | ∘ | ∘ | ∘ |
| Compatibility | x | x | x | x | x |

### Examples 17 to 23

Using the same process as in Examples 1 to 16, each set of components were mixed according to the formulation shown in Table 4 and stirred at 50° C. for 1 hour to form each of active energy ray-curable adhesive compositions according to Examples 17 to 23. In the table, each value indicates the content in units of % by weight based on 100% by weight of the total amount of the radically polymerizable compounds (the total amount of the radically polymerizable compounds (A) to (E)). Each resulting polarizing film was evaluated for adhering strength, water resistance (warm water immersion test), and durability (heat shock test) under the conditions shown below. The compatibility was evaluated under the same conditions as those shown above for the measurement of the compatibility. The following components were used.

(8) Photo-Acid Generator (G)

CPI-100P (a propylene carbonate solution containing 50% of active components including triarylsulfonium hexafluorophosphate as a main component) manufactured by SAN-APRO LTD.

(9) Compound (H) Containing Either an Alkoxy Group or an Epoxy Group

DENACOL EX-611 (sorbitol polyglycidyl ether) manufactured by Nagase ChemteX Corporation

Nicaresin S-260 (methylolated melamine) manufactured by NIPPON CARBIDE INDUSTRIES CO., INC.

KBM-5103 (3-acryloxypropyltrimethoxysilane) manufactured by Shin-Etsu Chemical Co., Ltd.

(10) Amino Group-Containing Silane Coupling Agent (I)

KBM-603 (γ-(2-aminoethyl)aminopropyltrimethoxysilane) manufactured by Shin-Etsu Chemical Co., Ltd.

KBM-602 (γ-(2-aminoethyl)aminopropylmethyldimethoxysilane) manufactured by Shin-Etsu Chemical Co., Ltd.

<Initial adhering strength>

The polarizing film was cut into a piece with a length of 200 mm parallel to the stretched direction of the polarizer and with a width of 15 mm in a direction perpendicular thereto. In the cut piece, an incision was made between the transparent protective film (acrylic resin film) and the polarizer with a cutter knife. The cut piece of the polarizing film was then bonded to a glass plate. The transparent protective film was peeled off from the polarizer at an angle of 90° and a peel rate of 300 mm/minute when the initial peel strength (N/15 mm) was measured using a Tensilon tester. Asa result, an initial peel strength of 0.5 N/15 mm or more was evaluated as ◯ (satisfactory) and an initial peel strength of less than 0.5 N/15 mm as x (unsatisfactory).

<Adhering Strength after Immersion in Warm Water (Evaluation of Water Resistance)>

The polarizing film was cut into a piece with a length of 200 mm parallel to the stretched direction of the polarizer and with a width of 15 mm in a direction perpendicular thereto. In the cut piece, an incision was made between the transparent protective film (acrylic resin film) and the polarizer with a cutter knife. The cut piece of the polarizing film was then bonded to a glass plate. The cut piece of the polarizing film was then immersed in warm water at 40° C. for 2 hours. Within 30 minutes (in an undried state) after the cut piece was taken out of the warm water, the protective film was peeled off from the polarizer at an angle of 90° and a peel rate of 300 mm/minute when the peel strength (N/15 mm) was measured using a Tensilon tester. As a result, a peel strength of 0.5 N/15 mm or more was evaluated as ◯ (satisfactory) and a peel strength of less than 0.5 N/15 mm as x (unsatisfactory).

<Durability (Heat Shock Test)>

A pressure-sensitive adhesive layer was formed on the surface of the polarizing coating of the polarizing film. The product was then cut into a rectangular piece with a width of 200 mm in the stretched direction of the polarizer and with a length of 400 mm in a direction perpendicular thereto. The cut piece of the polarizing film was laminated to a glass plate. The laminate was then subjected to a heat cycle test between −40° C. and 85° C. After 50 cycles, the polarizing film was visually observed and evaluated based on the criteria below.

◯: No cracking is observed.

Δ: Non-through cracking occurs in the stretched direction of the polarizer (a crack length of less than 200 mm)

x: Through cracking occurs in the stretched direction of the polarizer (a crack length of 200 mm)

TABLE 4

| | Example | Example | Example | Example | Example | Example | Example |
|---|---|---|---|---|---|---|---|
| | 17 | 18 | 19 | 20 | 21 | 22 | 23 |
| (A) HEAA | 11.9 | 11.4 | 11.9 | 11.9 | 11.9 | 11.9 | 11.9 |
| (B) ARONIX M-220 | 59.5 | 56.8 | 59.5 | 59.5 | 59.5 | 59.5 | 59.5 |
| (C) ACMO | 11.9 | 11.4 | 11.9 | 11.9 | 11.9 | 11.9 | 11.9 |
| (D) UP-1190 | 11.9 | 11.4 | 11.9 | 11.9 | 11.9 | 11.9 | 11.9 |
| (E) AAEM | 4.8 | 9.1 | | | | | |
| (H) DENACOL EX-611 | | | 4.8 | | | | |
| (H) Nicaresin S-260 | | | | 4.8 | | | |
| (H) KBM-5103 | | | | | 4.8 | | |
| (I) KBM-603 | | | | | | 4.8 | |
| (I) KBM-602 | | | | | | | 4.8 |
| (J) IRGACURE 907 | 2.9 | 2.7 | 2.9 | 2.9 | 2.9 | 2.9 | 2.9 |
| (F) KAYACURE DETX-S | 1.4 | 1.4 | 1.4 | 1.4 | 1.4 | 1.4 | 1.4 |
| (G) CPI-100P | | | 2.9 | 2.9 | 2.9 | | |
| Tg of cured | 65 | 60 | 63 | 63 | 63 | 63 | 63 |
| adhesive | | | | | | | |
| Initial adhering | ∘ | ∘ | ∘ | ∘ | ∘ | ∘ | ∘ |
| strength | | | | | | | |
| Adhering strength | ∘ | ∘ | ∘ | ∘ | ∘ | ∘ | ∘ |
| after warm water | | | | | | | |
| immersion | | | | | | | |
| Heat shock test | ∘ | ∘ | ∘ | ∘ | ∘ | ∘ | ∘ |
| Compatibility | ∘ | ∘ | ∘ | ∘ | ∘ | ∘ | ∘ |

The results in Table 4 show that curing products of adhesive compositions containing the components (A) to (D) and the active methylene group-containing radically polymerizable compound (E) in the presence of the radical polymerization initiator (F) having a hydrogen-withdrawing function have very high adhering strength after immersion in warm water and thus have high water resistance. The results also show that curing products of adhesive compositions containing the photo-acid generator (G) and the compound (H) containing ether an alkoxy group or an epoxy group and curing products of adhesive compositions containing the amino group-containing silane coupling agent (I) also have very high adhering strength after immersion in warm water and thus have high water resistance.

1. An active energy ray-curable adhesive composition comprising radically polymerizable compounds (A), (B) and (C) as curable components, and an acrylic oligomer (D) formed by polymerization of a (meth)acrylic monomer,
wherein the radically polymerizable compound (A) has an SP value of 29.0 (kJ/m³)^{1/2} to 32.0 (kJ/m³)^{1/2};
the radically polymerizable compound (B) has an SP value of 18.0 (kJ/m³)^{1/2} to less than 21.0 (kJ/m³)^{1/2};
the radically polymerizable compound (C) has an SP value of 21.0 (kJ/m³)^{1/2} to 23.0 (kJ/m³)^{1/2}; and
the composition contains 25 to 80% by weight of the radically polymerizable compound (B) based on 100% by weight of the total amount of the composition.

2. The active energy ray-curable adhesive composition according to claim 1, further comprising a radically polymerizable compound (E) having an active methylene group and a radical polymerization initiator (F) having a hydrogen-withdrawing function.

3. The active energy ray-curable adhesive composition according to claim 2, wherein the active methylene group is an acetoacetyl group.

4. The active energy ray-curable adhesive composition according to claim 2, wherein the radically polymerizable compound (E) having an active methylene group is acetoacetoxyalkyl (meth)acrylate.

5. The active energy ray-curable adhesive composition according to claim 2, wherein the radical polymerization initiator (F) is a thioxanthone radical polymerization initiator.

6. The active energy ray-curable adhesive composition according to claim 2, which contains 1 to 50% by weight of the radically polymerizable compound (E) having an active methylene group and 0.1 to 10% by weight of the radical polymerization initiator (F) based on 100% by weight of the total amount of the composition.

7. The active energy ray-curable adhesive composition according to claim 1, further comprising a photo-acid generator (G).

8. The active energy ray-curable adhesive composition according to claim 1, wherein the photo-acid generator (G) includes a photo-acid generator having at least one counter anion selected from the group consisting of PF₆⁻, SbF₆⁻, and AsF₆⁻.

9. The active energy ray-curable adhesive composition according to claim 1, further comprising a compound (H) having either an alkoxy group or an epoxy group in addition to the photo-acid generator (G).

10. The active energy ray-curable adhesive composition according to claim 1, further comprising an amino group-containing silane coupling agent (I).

11. The active energy ray-curable adhesive composition according to claim 10, which contains 0.01 to 20% by weight of the amino group-containing silane coupling agent (I) based on 100% by weight of the total amount of the composition.

12. The active energy ray-curable adhesive composition according to claim 1, which contains 3 to 40% by weight of the radically polymerizable compound (A), 5 to 55% by weight of the radically polymerizable compound (C), and 3 to 20% by weight of the acrylic oligomer (D) based on 100% by weight of the total amount of the composition.

13. The active energy ray-curable adhesive composition according to claim 1, wherein the radically polymerizable compounds (A), (B), and (C) are each capable of forming a homopolymer with a glass transition temperature (Tg) of 60° C. or higher.

14. The active energy ray-curable adhesive composition according to claim 1, wherein the radically polymerizable compound (A) is hydroxyethylacrylamide and/or N-methylolacrylamide.

15. The active energy ray-curable adhesive composition according to claim 1, wherein the radically polymerizable compound (B) is tripropylene glycol diacrylate.

16. The active energy ray-curable adhesive composition according to claim 1, wherein the radically polymerizable compound (C) is acryloylmorpholine and/or N-methoxymethylacrylamide.

17. The active energy ray-curable adhesive composition according to claim 1, further comprising, as a photopolymerization initiator, a compound represented by formula (1): 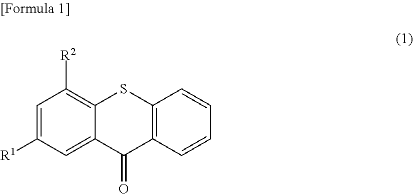
wherein R¹ and R² each represent —H, —CH₂CH₃, —IPR, or Cl, and R¹ and R² may be the same or different.

18. The active energy ray-curable adhesive composition according to claim 17, further comprising, as a photopolymerization initiator, a compound represented by formula (2): 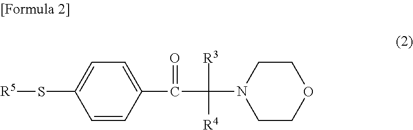
wherein R³, R⁴, and R⁵ each represent —H, —CH₃, —CH₂CH₃, —IPR, or Cl, and R³, R⁴, and R⁵ may be the same or different.

19. A polarizing film, comprising:
a polarizer;
an adhesive layer; and
a transparent protective film provided on at least one surface of the polarizer with the adhesive layer interposed therebetween, wherein
the transparent protective film has a transmittance of less than 5% for light with a wavelength of 365 nm, and
the adhesive layer is made of a cured material obtained by applying active energy rays to the composition according to claim 1.

20. The polarizing film according to claim 19, wherein the adhesive layer has a glass transition temperature (Tg) of 60° C. or higher.

21. The polarizing film according to claim 19, wherein the transparent protective film has a water-vapor permeability of 150 g/m²/24 hours or less.

22. The polarizing film according to claim 19, wherein the transparent protective film has an SP value of 29.0 (kJ/m³)^{1/2} to less than 33.0 (kJ/m³)^{1/2}.

23. The polarizing film according to claim 19, wherein the transparent protective film has an SP value of 18.0 (kJ/m³)^{1/2} to less than 24.0 (kJ/m³)^{1/2}.

24. A method for manufacturing a polarizing film comprising a polarizer, a transparent protective film provided on at least one surface of the polarizer and having a transmittance of less than 5% for light with a wavelength of 365 nm, and an adhesive layer interposed between the polarizer and the transparent protective film, the method comprising:
an application step comprising applying the active energy ray-curable adhesive composition according to claim 1 to a surface of at least one of the polarizer and the transparent protective film;
a lamination step comprising laminating the polarizer and the transparent protective film; and
a bonding step comprising curing the active energy ray-curable adhesive composition by applying active energy rays to the composition from a polarizer side or a transparent protective film side to form an adhesive layer, so that the polarizer and the transparent protective film are bonded with the adhesive layer interposed therebetween.

25. The method according to claim 24, further comprising subjecting a surface of at least one of the polarizer and the transparent protective film to a corona treatment, a plasma treatment, an excimer treatment, or a flame treatment before the application step, wherein the surface is to be subjected to the lamination.

26. The method according to claim 24, wherein
the polarizing film comprises a polarizer, transparent protective films provided on both sides of the polarizer and each having a transmittance of less than 5% for light with a wavelength of 365 nm, and adhesive layers each interposed between the polarizer and the transparent protective film, and
the bonding step comprises curing the active energy ray-curable adhesive composition by first applying active energy rays to the composition from one transparent productive film side and then applying active energy rays to the composition from another transparent protective film side to form adhesive layers, so that the polarizer and the transparent protective films are bonded with the adhesive layers interposed therebetween.

27. The method according to claim 24, wherein the active energy rays include visible rays with a wavelength ranging from 380 nm to 450 nm.

28. The method according to claim 24, wherein the active energy rays are such that the ratio of the total illuminance in the wavelength range of 380 nm to 440 nm to the total illuminance in the wavelength range of 250 nm to 370 nm is from 100:0 to 100:50.

29. The method according to claim 24, wherein the polarizer has a water content of less than 15% during the lamination step.

30. An optical film comprising a laminate including at least one piece of the polarizing film according to claim 19.

31. An image display device comprising the polarizing film and/or the optical film according to claim 30.
